(19) United States
(12) Patent Application Publication
(10) Pub. No.: US 2021/0157442 A1
(43) Pub. Date: May 27, 2021

(54) INTERACTION TOUCH OBJECTS

(71) Applicant: Beechrock Limited, Castletown (IM)

(72) Inventors: Owen Drumm, Dublin (IE); Emma Branigan, Dublin (IE); Karl Dwyer, Dublin (IE); Dermot O'Moore, Dublin (IE)

(21) Appl. No.: 17/105,301

(22) Filed: Nov. 25, 2020

Related U.S. Application Data
(60) Provisional application No. 62/940,224, filed on Nov. 25, 2019.

(51) Int. Cl. G06F 3/042; G06F 3/041; G06F 3/0484; G06F 3/0488

(52) U.S. Cl. CPC G06F 3/0421; G06F 3/04883; G06F 3/0484; G06F 3/0416

(57) ABSTRACT

An interaction object can attach to a touch surface of a touch-sensitive device. The interaction object includes one or more contact portions that cause one or more touch events on the surface. The contact portions may have specific shapes or sizes or be arranged in a specific manner so that the touch-sensitive device can distinguish the interaction object from other touch objects that cause touch events (e.g., fingers or styli). Responsive to the touch-sensitive device recognizing an interaction object, a display may display a user interface associated with the identified interaction object. The user interface may allow a user to interact with the touch-sensitive device in ways that are intuitive and more efficient than conventional interaction techniques.

### CROSS REFERENCE TO RELATED APPLICATIONS

This application claims the benefit of priority to U.S. Provisional Patent Application No. 62/940,224, “Interactive Display Objects,” filed on Nov. 25, 2019, which is incorporated by reference in its entirety.

### BACKGROUND

### 1. Field of Art

This description generally relates to touch objects interacting with a touch-sensitive device, and specifically to interactive touch objects that attach to a touch surface of the touch-sensitive device.

### 2. Description of the Related Art

Touch-sensitive displays for interacting with computing devices are becoming more common. A number of different technologies exist for implementing touch-sensitive displays and other touch-sensitive devices. Examples of these techniques include, for example, resistive touch screens, surface acoustic wave touch screens, capacitive touch screens and certain types of optical touch screens.

While touch objects are generally fingers, solutions exist to support detection of other touch objects types, such as styli. However these touch objects are often limited in their functions and their ability to interact with the touch-sensitive display. Furthermore, since these touch objects are not attached to the touch-sensitive display they can be lost or forgotten by a user.

### SUMMARY

An interaction touch object (also referred to as an interaction object) can attach to a touch surface of a touch-sensitive device. The interaction object includes one or more contact portions that cause one or more touch events on the surface. The contact portions may have specific shapes or sizes or be arranged in a specific manner so that the touch-sensitive device can distinguish the interaction object from other touch objects that cause touch events (e.g., fingers or styli). Responsive to the touch-sensitive device recognizing an interaction object, a display (e.g., behind the touch surface) may display one or more images (e.g., a user interface) associated with the identified interaction object. The images may allow a user to interact with the touch-sensitive device in ways that are intuitive and more efficient than conventional interaction techniques.

Some embodiments relate to a system including a touch surface, emitters, detectors, an interaction touch object, and a controller. The emitters produce optical beams that propagate across the touch surface and are received by the detectors, where touch events on the touch surface disturb the optical beams. The interaction touch object attaches to the touch surface and causes a touch event when the interaction touch object is attached to the touch surface by disturbing one or more beams emitted by the emitters. The controller receives beam data from the detectors for optical beams disturbed by the interaction touch object. The controller determines a location and another characteristic of the touch event caused by the interaction object based on the beam data. The controller determines the interaction touch object is on the touch surface based on the other characteristic and determines a location of the interaction touch object based on the location of the touch event.

Some embodiments relate to an interaction touch object that interacts with a touch-sensitive device. The touch-sensitive device detects touch events on a touch surface. The object includes a mounting coupler and a contact portion. Responsive to a user placing the object on the touch surface, the mounting coupler attaches the interaction object to the touch surface. The contact portion contacts the touch surface and causes a touch event when the interaction object is attached to the touch surface by the mounting coupler. The touch-sensitive device determines the interaction touch object is on the touch surface based on a characteristic of the touch event caused by the contact portion.

Some embodiments relate to a method of interacting with an interaction touch object by a touch-sensitive device. The touch-sensitive device detects touch events on a touch surface. The touch surface is in front of a display that is coupled to the touch-sensitive device. The method includes receiving touch data from one or more detectors of the touch-sensitive device. The touch data indicates one or more touch events on the touch surface. The method steps may be performed by a controller of the touch-sensitive device. The method further includes determining locations and another characteristic of the one or more touch events on the touch surface based on the touch data. The method further includes determining an interaction touch object is on the touch surface based on the other characteristic. The interaction touch object is attached to the touch surface and includes a contact portion in contact with the touch surface. The contact portion causes the one or more touch events. The method further includes determining a location of the interaction touch object based on the locations of the one or more touch events. The method further includes, responsive to determining the interaction touch object is on the touch surface and determining the location of the interaction touch object, sending instructions to the display to display a user interface associated with the interaction touch object. A location of the user interface on the display is based on the location of the interaction touch object on the touch surface. For example, portions of the user interface on the display may be displayed above, below, and/or on sides of the interaction touch object on the touch surface.

In some embodiments, the method further includes determining an orientation of the interaction touch object relative to the touch surface. The orientation of the user interface may be based on the orientation of the interaction touch object. Additionally or alternatively, the method may further include determining a type of the interaction touch object based on a characteristic (e.g., the other characteristic or another characteristic) of the of the one or more touch events. The user interface is selected based on the type of the interaction touch object.

As described above, the interaction touch object may cause one or more touch events on the touch surface. These touch events have one or more characteristics. Example characteristics include shapes of the one or more touch events, sizes of the one or more touch events, a total number of the one or more touch events, orientations of the one or more touch events, changes to the location of the one or more touch events within a threshold time period, locations of the one or more touch events relative to each other, and time of occurrences of the touch events relative to each other.

The interaction touch object may include a user-interactable control. Example controls include sliders, buttons, and rotary controls. An interaction with the control (e.g., by the user) may change one or more characteristics of the one or more touch events caused by the interaction touch object. For example, interacting with the control increases the size of a touch event or increases the number of touch events caused by the interaction touch object. If the touch-sensitive device is an optical touch sensitive device, an interaction may change the how the interaction object disturbs one or more beams emitted by an emitter.

In some embodiments, the interaction touch object is removably attached to the touch surface. For example, the interaction object is magnetically attached to the touch surface. In other examples, the interaction object includes a sucker, a hook and loop fastener, or releasable adhesive to removably attach the interaction touch object to the touch surface. In other cases, the interaction object is permanently attached to the touch surface (e.g., via adhesive).

### BRIEF DESCRIPTION OF DRAWINGS

Embodiments of the present disclosure will now be described, by way of example, with reference to the accompanying drawings.

FIG. 1 is a diagram of an optical touch-sensitive device, according to an embodiment.

FIG. 2 is a flow diagram for determining the characteristics of touch events, according to an embodiment.

FIG. 3A-3F illustrate example mechanisms for a touch interaction with an optical beam, according to some embodiments.

FIG. 4 is a graph of binary and analog touch interactions, according to an embodiment.

FIGS. 5A-5C are top views of differently shaped beam footprints, according to some embodiments.

FIGS. 6A-6B are top views illustrating a touch point travelling through a narrow beam and a wide beam, respectively, according to some embodiments.

FIG. 7 is a graph of the binary and analog responses for the narrow and wide beams of FIG. 6, according to some embodiments.

FIGS. 8A and 8B are top views illustrating active touch area coverage by emitters, according to some embodiments.

FIGS. 8C and 8D are top views illustrating active touch area coverage by detectors, according to some embodiments.

FIG. 8E is a top view illustrating alternating emitters and detectors, according to an embodiment.

FIGS. 9A-9C are top views illustrating beam patterns interrupted by a touch point, from the viewpoint of different beam terminals, according to some embodiments.

FIG. 9D is a top view illustrating estimation of the touch point, based on the interrupted beams of FIGS. 9A-9C and the line images of FIGS. 10A-10C, according to an embodiment.

FIGS. 10A-10C are graphs of line images corresponding to the cases shown in FIGS. 9A-9C, according to some embodiments.

FIG. 11A is a top view illustrating a touch point travelling through two adjacent wide beams, according to an embodiment.

FIG. 11B are graphs of the analog responses for the two wide beams of FIG. 11A, according to some embodiments.

FIG. 11C is a top view illustrating a touch point travelling through many adjacent narrow beams, according to an embodiment.

FIGS. 12A-12E are top views of beam paths illustrating templates for touch events, according to some embodiments.

FIG. 13 is a flow diagram of a multi-pass method for determining touch locations, according to some embodiments.

FIG. 14 includes cross sectional images of an interaction object attached to a waveguide of an optical touch-sensitive device, according to an embodiment.

FIG. 15 is a perspective view of a rectangular interaction object, according to an embodiment.

FIG. 16 is a perspective view of another interaction object, according to an embodiment.

FIG. 17. shows three different interaction objects on a display, according to an embodiment.

FIG. 18 is a flow chart illustrating a method of interacting with an interaction touch object by a touch-sensitive device, according to an embodiment.

### DETAILED DESCRIPTION

### I. Introduction

A. Device Overview

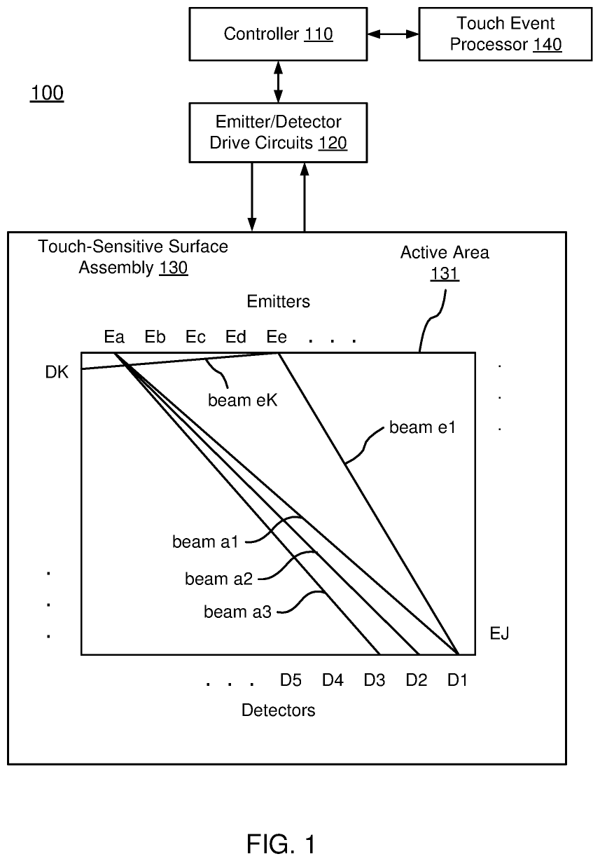

FIG. 1 is a diagram of an optical touch-sensitive device 100 (also referred to as a touch system, touch-sensitive device, or touch sensor), according to one embodiment. The optical touch-sensitive device 100 includes a controller 110, emitter/detector drive circuits 120, and a touch-sensitive surface assembly 130. The surface assembly 130 includes a surface 131 over which touch events are to be detected. For convenience, the area defined by surface 131 may sometimes be referred to as the active touch area, touch surface, or active touch surface, even though the surface itself may be an entirely passive structure. The assembly 130 also includes emitters and detectors arranged along the periphery of the active touch surface 131. In this example, there are J emitters labeled as Ea-EJ and K detectors labeled as D1-DK. The device also includes a touch event processor 140, which may be implemented as part of the controller 110 or separately as shown in FIG. 1. A standardized API may be used to communicate with the touch event processor 140, for example between the touch event processor 140 and controller 110, or between the touch event processor 140 and other devices connected to the touch event processor.

The emitter/detector drive circuits 120 serve as an interface between the controller 110 and the emitters Ej and detectors Dk. The emitters produce optical “beams” which are received by the detectors. Preferably, the light produced by one emitter is received by more than one detector, and each detector receives light from more than one emitter. For convenience, “beam” will refer to the light from one emitter to one detector, even though it may be part of a large fan of light that goes to many detectors rather than a separate beam. The beam from emitter Ej to detector Dk will be referred to as beam jk. FIG. 1 expressly labels beams a1, a2, a3, el and eK as examples. Touches within the active touch area 131 will disturb certain beams, thus changing what is received at the detectors Dk. Data about these changes is communicated to the touch event processor 140, which analyzes the data to determine the location(s) (and times) of touch events on surface 131.

The emitters and detectors may be interleaved around the periphery of the sensitive surface. In other embodiments, the number of emitters and detectors are different and are distributed around the periphery in any defined order. The emitters and detectors may be regularly or irregularly spaced. In some cases, the emitters and/or detectors may be located on less than all of the sides (e.g., one side). In some embodiments, the emitters and/or detectors are not located around the periphery (e.g., beams are directed to/from the active touch area 131 by optical beam couplers). Reflectors may also be positioned around the periphery to reflect optical beams, causing the path from the emitter to the detector to pass across the surface more than once.

One advantage of an optical approach as shown in FIG. 1 is that this approach scales well to larger screen sizes compared to conventional touch devices that cover an active touch area with sensors, such as resistive and capacitive sensors. Since the emitters and detectors may be positioned around the periphery, increasing the screen size by a linear factor of N means that the periphery also scales by a factor of N compared to N² for conventional touch devices.

For convenience, in the remainder of this description, touch objects are described as disturbing beams. Disturbed beams are beams affected by a touch object that would otherwise not be affected if the object did not interact with the touch device 100. Depending on the construction of the touch object, disturbing may include blocking, absorbing, attenuating, amplifying, scattering, reflecting, refracting, diffracting, filtering, redirecting, etc.

In this description, touch objects are described and illustrated as disturbing beams when they are in contact with the touch surface. A touch object in contact with a touch surface is defined to include an object physically contacting the surface and an object in close enough proximity to disturb beams. For example, a stylus interacting with an OTS touch surface is in contact with the surface (even if it is not physically contacting the surface) if the stylus is disturbing beams propagating over the surface. In another example, for TIR touch device, a touch event can occur even if a touch object is not in direct contact with the surface of the waveguide. If a distance between the touch object and the surface of the waveguide is less than or equal to the evanescent field of the beams (e.g., 2 μm), the touch object may disturb the beams and the touch system may determine that a touch event occurred.

B. Process Overview

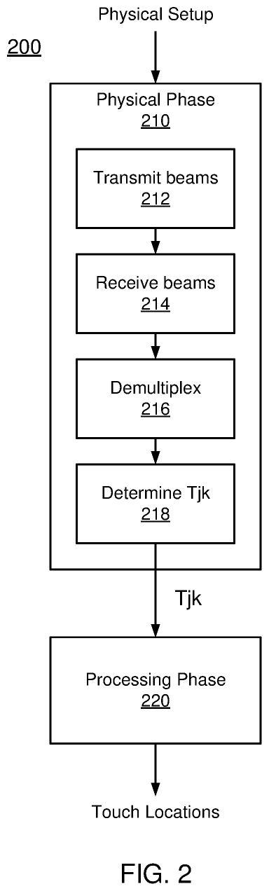

FIG. 2 is a flow diagram for determining the characteristics of touch events, according to an embodiment. This process will be illustrated using the device of FIG. 1. The process 200 is roughly divided into two phases, which will be referred to as a physical phase 210 and a processing phase 220. Conceptually, the dividing line between the two phases is a set of transmission coefficients Tjk (also referred to as transmission values Tjk).

The transmission coefficient Tjk is the transmittance of the optical beam from emitter j to detector k, compared to what would have been transmitted if there was no touch event interacting with the optical beam. In the following examples, we will use a scale of 0 (fully blocked beam) to 1 (fully transmitted beam). Thus, a beam jk that is undisturbed by a touch event has Tjk=1. A beam jk that is fully blocked by a touch event has a Tjk=0. A beam jk that is partially blocked or attenuated by a touch event has 0<Tjk<1. It is possible for Tjk>1, for example depending on the nature of the touch interaction or in cases where light is deflected or scattered to detectors k that it normally would not reach.

The use of this specific measure is purely an example. Other measures can be used. In particular, since we are most interested in interrupted beams, an inverse measure such as (1−Tjk) may be used since it is normally 0. Other examples include measures of absorption, attenuation, reflection, or scattering. In addition, although FIG. 2 is explained using Tjk as the dividing line between the physical phase 210 and the processing phase 220, it is not required that Tjk be expressly calculated. Nor is a clear division between the physical phase 210 and processing phase 220 required.

Returning to FIG. 2, the physical phase 210 is the process of determining the Tjk from the physical setup. The processing phase 220 determines the touch events from the Tjk. The model shown in FIG. 2 is conceptually useful because it somewhat separates the physical setup and underlying physical mechanisms from the subsequent processing.

For example, the physical phase 210 produces transmission coefficients Tjk. Many different physical designs for the touch-sensitive surface assembly 130 are possible, and different design tradeoffs will be considered depending on the end application. For example, the emitters and detectors may be narrower or wider, narrower angle or wider angle, various wavelengths, various powers, coherent or not, etc. As another example, different types of multiplexing may be used to allow beams from multiple emitters to be received by each detector. Several of these physical setups and manners of operation are described below, primarily in Section II.

The interior of block 210 shows one possible implementation of process 210. In this example, emitters transmit 212 beams to multiple detectors. Some of the beams travelling across the touch-sensitive surface are disturbed by touch events. The detectors receive 214 the beams from the emitters in a multiplexed optical form. The received beams are de-multiplexed 216 to distinguish individual beams jk from each other. Transmission coefficients Tjk for each individual beam jk are then determined 218.

The processing phase 220 computes the touch characteristics and can be implemented in many different ways. Candidate touch points, line imaging, location interpolation, touch event templates and multi-pass approaches are all examples of techniques that may be used to compute the touch characteristics (such as touch location and touch strength) as part of the processing phase 220. Several of these are identified in Section III.

### II. Physical Set-up

The touch-sensitive device 100 may be implemented in a number of different ways. The following are some examples of design variations.

A. Electronics

With respect to electronic aspects, note that FIG. 1 is exemplary and functional in nature. Functions from different boxes in FIG. 1 can be implemented together in the same component.

For example, the controller 110 and touch event processor 140 may be implemented as hardware, software or a combination of the two. They may also be implemented together (e.g., as an SoC with code running on a processor in the SoC) or separately (e.g., the controller as part of an ASIC, and the touch event processor as software running on a separate processor chip that communicates with the ASIC). Example implementations include dedicated hardware (e.g., ASIC or programmed field programmable gate array (FPGA)), and microprocessor or microcontroller (either embedded or standalone) running software code (including firmware). Software implementations can be modified after manufacturing by updating the software.

The emitter/detector drive circuits 120 serve as an interface between the controller 110 and the emitters and detectors. In one implementation, the interface to the controller 110 is at least partly digital in nature. With respect to emitters, the controller 110 may send commands controlling the operation of the emitters. These commands may be instructions, for example a sequence of bits which mean to take certain actions: start/stop transmission of beams, change to a certain pattern or sequence of beams, adjust power, power up/power down circuits. They may also be simpler signals, for example a “beam enable signal,” where the emitters transmit beams when the beam enable signal is high and do not transmit when the beam enable signal is low.

The circuits 120 convert the received instructions into physical signals that drive the emitters. For example, circuit 120 might include some digital logic coupled to digital to analog converters, in order to convert received digital instructions into drive currents for the emitters. The circuit 120 might also include other circuitry used to operate the emitters: modulators to impress electrical modulations onto the optical beams (or onto the electrical signals driving the emitters), control loops and analog feedback from the emitters, for example. The emitters may also send information to the controller, for example providing signals that report on their current status.

With respect to the detectors, the controller 110 may also send commands controlling the operation of the detectors, and the detectors may return signals to the controller. The detectors also transmit information about the beams received by the detectors. For example, the circuits 120 may receive raw or amplified analog signals from the detectors. The circuits then may condition these signals (e.g., noise suppression), convert them from analog to digital form, and perhaps also apply some digital processing (e.g., demodulation).

B. Touch Interactions

Not all touch objects are equally good beam attenuators, as indicated by their transmission coefficient Tjk. Beam attenuation mainly depends on the optical transparency of the object and the volume of the object portion that is interacting with the beam, i.e. the object portion that intersects the beam propagation volume.

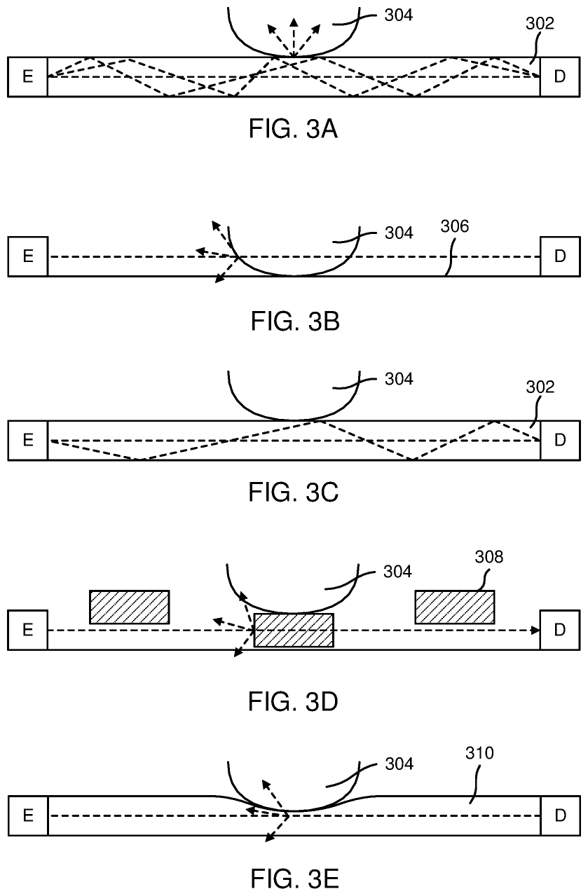

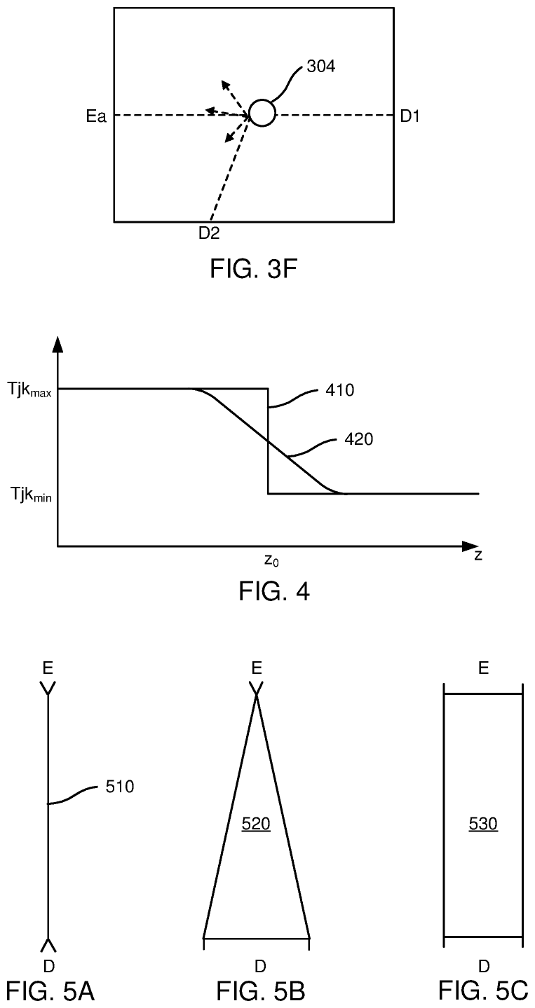

FIGS. 3A-3F illustrate different mechanisms for a touch interaction with an optical beam. FIG. 3A illustrates a mechanism based on frustrated total internal reflection (TIR). The optical beam, shown as a dashed line, travels from emitter E to detector D through an optically transparent planar waveguide 302. The beam is confined to the waveguide 302 by total internal reflection. The waveguide may be constructed of plastic or glass, for example. An object 304, such as a finger or stylus, coming into contact with the transparent waveguide 302, has a higher refractive index than the air normally surrounding the waveguide. Over the area of contact, the increase in the refractive index due to the object disturbs the total internal reflection of the beam within the waveguide. The disruption of total internal reflection increases the light leakage from the waveguide, attenuating any beams passing through the contact area. Correspondingly, removal of the object 304 will stop the attenuation of the beams passing through. Attenuation of the beams passing through the touch point will result in less power at the detectors, from which the reduced transmission coefficients Tjk can be calculated.

FIG. 3B illustrates a mechanism based on beam blockage (also referred to as an “over the surface” (OTS) configuration). Emitters produce beams which are in close proximity to a surface 306. An object 304 coming into contact with the surface 306 will partially or entirely block beams within the contact area. Since the beams propagate over the surface 306, the object 304 may block the beam even if it is not in direct contact with the surface. FIGS. 3A and 3B illustrate two physical mechanisms for touch interactions, but other mechanisms can also be used. For example, the touch interaction may be based on changes in polarization, scattering, or changes in propagation direction or propagation angle (either vertically or horizontally).

For example, FIG. 3C illustrates a different mechanism based on propagation angle. In this example, the optical beam is guided in a waveguide 302 via TIR. The optical beam hits the waveguide-air interface at a certain angle and is reflected back at the same angle. However, the touch 304 changes the angle at which the optical beam is propagating, and may also absorb some of the incident light. In FIG. 3C, the optical beam travels at a steeper angle of propagation after the touch 304. Note that changing the angle of the light may also cause it to fall below the critical angle for total internal reflection, whereby it will leave the waveguide. The detector D has a response that varies as a function of the angle of propagation. The detector D could be more sensitive to the optical beam travelling at the original angle of propagation or it could be less sensitive. Regardless, an optical beam that is disturbed by a touch 304 will produce a different response at detector D.

In FIGS. 3A-3C, the touching object was also the object that interacted with the beam. This will be referred to as a direct interaction. In an indirect interaction, the touching object interacts with an intermediate object, which interacts with the optical beam. FIG. 3D shows an example that uses intermediate blocking structures 308. Normally, these structures 308 do not block the beam. However, in FIG. 3D, object 304 contacts the blocking structure 308, which causes it to partially or entirely block the optical beam. In FIG. 3D, the structures 308 are shown as discrete objects, but they do not have to be so.

In FIG. 3E, the intermediate structure 310 is a compressible, partially transmitting sheet. When there is no touch, the sheet attenuates the beam by a certain amount. In FIG. 3E, the touch 304 compresses the sheet, thus changing the attenuation of the beam. For example, the upper part of the sheet may be more opaque than the lower part, so that compression decreases the transmittance. Alternatively, the sheet may have a certain density of scattering sites. Compression increases the density in the contact area, since the same number of scattering sites occupies a smaller volume, thus decreasing the transmittance. Analogous indirect approaches can also be used for frustrated TIR. Note that this approach could be used to measure contact pressure or touch velocity, based on the degree or rate of compression.

The touch mechanism may also enhance transmission, instead of or in addition to reducing transmission. For example, the touch interaction in FIG. 3E might increase the transmission instead of reducing it. The upper part of the sheet may be more transparent than the lower part, so that compression increases the transmittance.

FIG. 3F shows another example where the transmittance between an emitter and detector increases due to a touch interaction. FIG. 3F is a top view. Emitter Ea normally produces a beam that is received by detector D1. When there is no touch interaction, Ta1=1 and Ta2=0. However, a touch interaction 304 blocks the beam from reaching detector D1 and scatters some of the blocked light to detector D2. Thus, detector D2 receives more light from emitter Ea than it normally would. Accordingly, when there is a touch event 304, Ta1 decreases and Ta2 increases.

For simplicity, in the remainder of this description, the touch mechanism will be assumed to be primarily of a blocking nature, meaning that a beam from an emitter to a detector will be partially or fully blocked by an intervening touch event. This is not required, but it is convenient to illustrate various concepts.

For convenience, the touch interaction mechanism may sometimes be classified as either binary or analog. A binary interaction is one that basically has two possible responses as a function of the touch. Examples includes non-blocking and fully blocking, or non-blocking and 10%+ attenuation, or not frustrated and frustrated TIR. An analog interaction is one that has a “grayscale” response to the touch: non-blocking passing through gradations of partially blocking to blocking. Whether the touch interaction mechanism is binary or analog depends in part on the nature of the interaction between the touch and the beam. It does not depend on the lateral width of the beam (which can also be manipulated to obtain a binary or analog attenuation, as described below), although it might depend on the vertical size of the beam.

FIG. 4 is a graph illustrating a binary touch interaction mechanism compared to an analog touch interaction mechanism. FIG. 4 graphs the transmittance Tjk as a function of the depth z of the touch. The dimension z is into and out of the active touch surface. Curve 410 is a binary response. At low z (i.e., when the touch has not yet disturbed the beam), the transmittance Tjk is at its maximum. However, at some point zO, the touch breaks the beam and the transmittance Tjk falls fairly suddenly to its minimum value. Curve 420 shows an analog response where the transition from maximum Tjk to minimum Tjk occurs over a wider range of z. If curve 420 is well behaved, it is possible to estimate z from the measured value of Tjk.

C. Emitters, Detectors and Couplers

Each emitter transmits light to a number of detectors. Usually, each emitter outputs light to more than one detector simultaneously. Similarly, each detector may receive light from a number of different emitters. The optical beams may be visible, infrared (IR) and/or ultraviolet light. The term “light” is meant to include all of these wavelengths and terms such as “optical” are to be interpreted accordingly.

Examples of the optical sources for the emitters include light emitting diodes (LEDs) and semiconductor lasers. IR sources can also be used. Modulation of optical beams can be achieved by directly modulating the optical source or by using an external modulator, for example a liquid crystal modulator or a deflected mirror modulator. Examples of sensor elements for the detector include charge coupled devices, photodiodes, photoresistors, phototransistors, and nonlinear all-optical detectors. Typically, the detectors output an electrical signal that is a function of the intensity of the received optical beam.

The emitters and detectors may also include optics and/or electronics in addition to the main optical source and sensor element. For example, optics can be used to couple between the emitter/detector and the desired beam path. Optics can also reshape or otherwise condition the beam produced by the emitter or accepted by the detector. These optics may include lenses, Fresnel lenses, mirrors, filters, non-imaging optics and other optical components.

In this disclosure, the optical paths are shown unfolded for clarity. Thus, sources, optical beams and sensors are shown as lying in one plane. In actual implementations, the sources and sensors typically do not lie in the same plane as the optical beams. Various coupling approaches can be used. For example, a planar waveguide or optical fiber may be used to couple light to/from the actual beam path. Free space coupling (e.g., lenses and mirrors) may also be used. A combination may also be used, for example waveguided along one dimension and free space along the other dimension. Various coupler designs are described in U.S. Pat. No. 9,170,683, entitled “Optical Coupler,” which is incorporated by reference herein.

D. Optical Beam Paths

Another aspect of a touch-sensitive system is the shape and location of the optical beams and beam paths. In FIG. 1, the optical beams are shown as lines. These lines should be interpreted as representative of the beams, but the beams themselves are not necessarily narrow pencil beams. FIGS. 5A-5C illustrate different beam shapes when projected onto the active touch surface (beam footprint).

FIG. 5A shows a point emitter E, point detector D and a narrow “pencil” beam 510 from the emitter to the detector. In FIG. 5B, a point emitter E produces a fan-shaped beam 520 received by the wide detector D. In FIG. 5C, a wide emitter E produces a “rectangular” beam 530 received by the wide detector D. These are top views of the beams and the shapes shown are the footprints of the beam paths. Thus, beam 510 has a line-like footprint, beam 520 has a triangular footprint which is narrow at the emitter and wide at the detector, and beam 530 has a fairly constant width rectangular footprint. In FIG. 5, the detectors and emitters are represented by their widths, as seen by the beam path. The actual optical sources and sensors may not be so wide. Rather, optics (e.g., cylindrical lenses or mirrors) can be used to effectively widen or narrow the lateral extent of the actual sources and sensors.

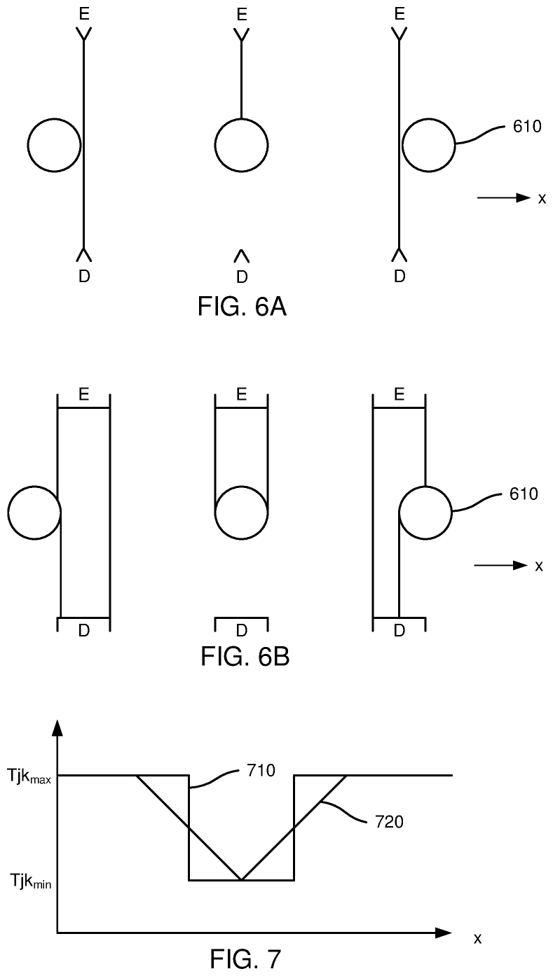

FIGS. 6A-6B and 7 show, for a constant z position and various x positions, how the width of the footprint can determine whether the transmission coefficient Tjk behaves as a binary or analog quantity. In these figures, a touch point has contact area 610. Assume that the touch is fully blocking, so that any light that hits contact area 610 will be blocked. FIG. 6A shows what happens as the touch point moves left to right past a narrow beam. In the leftmost situation, the beam is not blocked at all (i.e., maximum Tjk) until the right edge of the contact area 610 interrupts the beam. At this point, the beam is fully blocked (i.e., minimum Tjk), as is also the case in the middle scenario. It continues as fully blocked until the entire contact area moves through the beam. Then, the beam is again fully unblocked, as shown in the righthand scenario. Curve 710 in FIG. 7 shows the transmittance Tjk as a function of the lateral position x of the contact area 610. The sharp transitions between minimum and maximum Tjk show the binary nature of this response.

FIG. 6B shows what happens as the touch point moves left to right past a wide beam. In the leftmost scenario, the beam is just starting to be blocked. The transmittance Tjk starts to fall off but is at some value between the minimum and maximum values. The transmittance Tjk continues to fall as the touch point blocks more of the beam, until the middle situation where the beam is fully blocked. Then the transmittance Tjk starts to increase again as the contact area exits the beam, as shown in the righthand situation. Curve 720 in FIG. 7 shows the transmittance Tjk as a function of the lateral position x of the contact area 610. The transition over a broad range of x shows the analog nature of this response.

E. Active Area Coverage

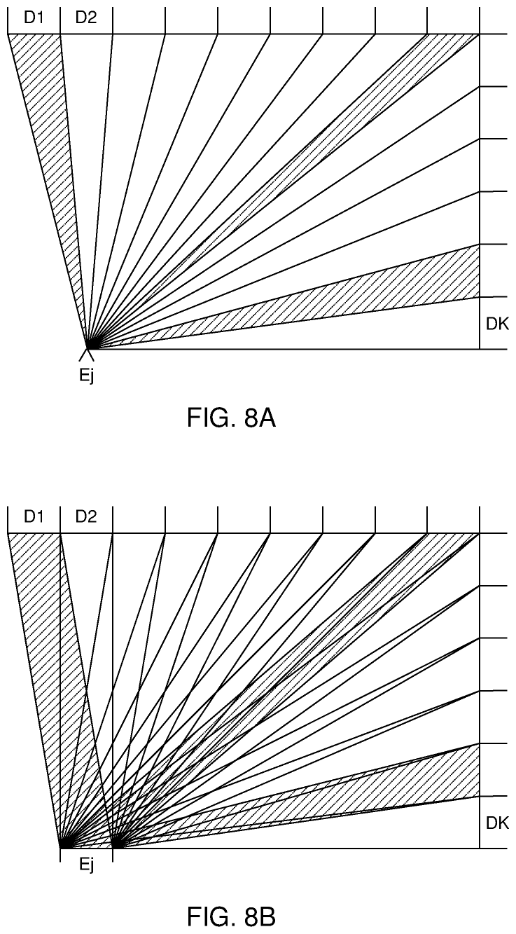

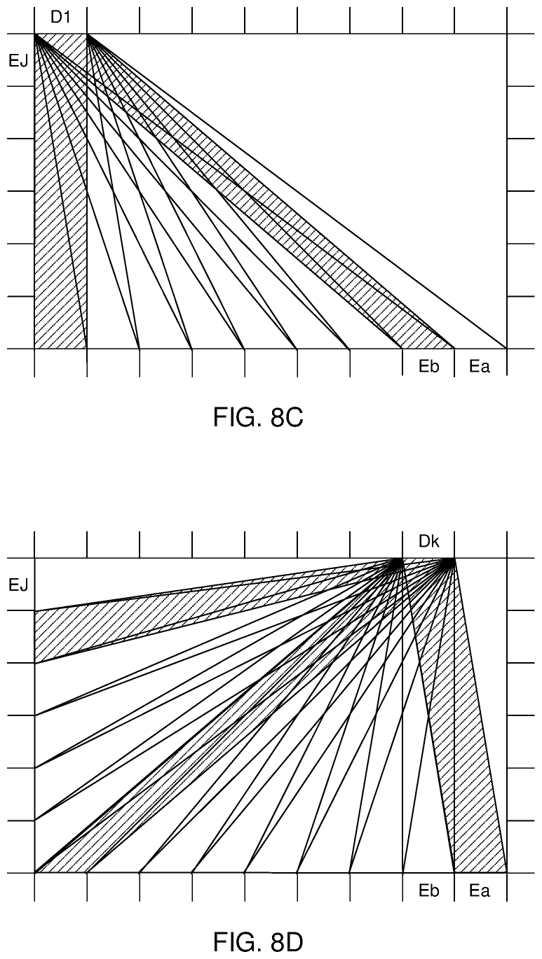

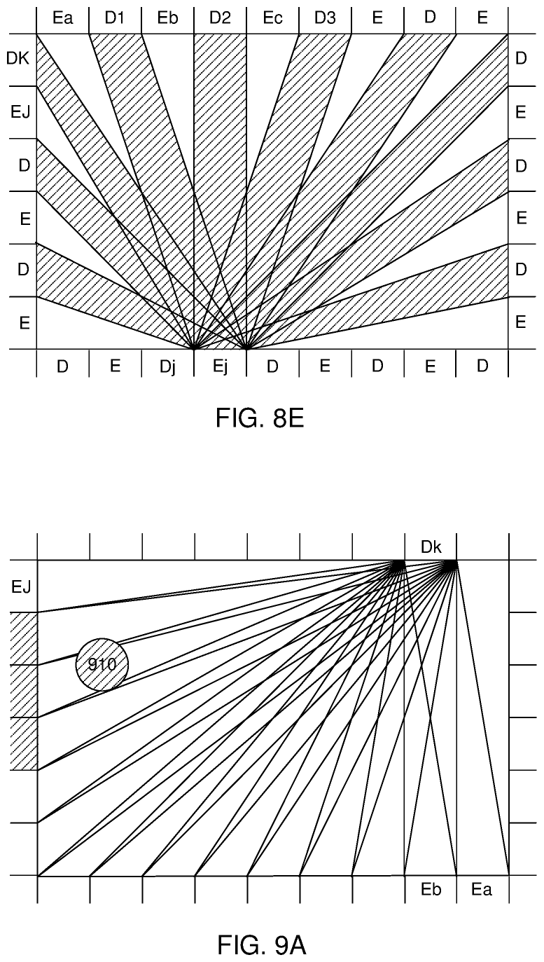

FIG. 8A is a top view illustrating the beam pattern produced by a point emitter. Emitter Ej transmits beams to wide detectors D1-DK. Three beams are shaded for clarity: beam j1, beam j(K−1) and an intermediate beam. Each beam has a fan-shaped footprint. The aggregate of all footprints is emitter Ej's coverage area. That is, any touch event that falls within emitter Ej's coverage area will disturb at least one of the beams from emitter Ej. FIG. 8B is a similar diagram, except that emitter Ej is a wide emitter and produces beams with “rectangular” footprints (actually, trapezoidal but they are referred to as rectangular for convenience). The three shaded beams are for the same detectors as in FIG. 8A.

Note that every emitter Ej may not produce beams for every detector Dk. In FIG. 1, consider beam path aK which would go from emitter Ea to detector DK. First, the light produced by emitter Ea may not travel in this direction (i.e., the radiant angle of the emitter may not be wide enough) so there may be no physical beam at all, or the acceptance angle of the detector may not be wide enough so that the detector does not detect the incident light. Second, even if there was a beam and it was detectable, it may be ignored because the beam path is not located in a position to produce useful information. Hence, the transmission coefficients Tjk may not have values for all combinations of emitters Ej and detectors Dk.

The footprints of individual beams from an emitter and the coverage area of all beams from an emitter can be described using different quantities. Spatial extent (i.e., width), angular extent (i.e., radiant angle for emitters, acceptance angle for detectors), and footprint shape are quantities that can be used to describe individual beam paths as well as an individual emitter's coverage area.

An individual beam path from one emitter Ej to one detector Dk can be described by the emitter Ej's width, the detector Dk's width and/or the angles and shape defining the beam path between the two.

These individual beam paths can be aggregated over all detectors for one emitter Ej to produce the coverage area for emitter Ej. Emitter Ej's coverage area can be described by the emitter Ej's width, the aggregate width of the relevant detectors Dk and/or the angles and shape defining the aggregate of the beam paths from emitter Ej. Note that the individual footprints may overlap (see FIG. 8B close to the emitter). Therefore, an emitter's coverage area may not be equal to the sum of its footprints. The ratio of (the sum of an emitter's footprints)/(emitter's cover area) is one measure of the amount of overlap.

The coverage areas for individual emitters can be aggregated over all emitters to obtain the overall coverage for the system. In this case, the shape of the overall coverage area is not so interesting because it should cover the entirety of the active touch area 131. However, not all points within the active touch area 131 will be covered equally. Some points may be traversed by many beam paths while other points traversed by far fewer. The distribution of beam paths over the active touch area 131 may be characterized by calculating how many beam paths traverse different (x,y) points within the active touch area. The orientation of beam paths is another aspect of the distribution. An (x,y) point that is derived from three beam paths that are all running roughly in the same direction usually will be a weaker distribution than a point that is traversed by three beam paths that all run at 60 degree angles to each other.

The discussion above for emitters also holds for detectors. The diagrams constructed for emitters in FIGS. 8A-8B can also be constructed for detectors. For example, FIG. 8C shows a similar diagram for detector D1 of FIG. 8B. That is, FIG. 8C shows all beam paths received by detector D1. Note that in this example, the beam paths to detector D1 are only from emitters along the bottom edge of the active touch area. The emitters on the left edge are not worth connecting to D1 and there are no emitters on the right edge (in this example design). FIG. 8D shows a diagram for detector Dk, which is an analogous position to emitter Ej in FIG. 8B.

A detector Dk's coverage area is then the aggregate of all footprints for beams received by a detector Dk. The aggregate of all detector coverage areas gives the overall system coverage.

The coverage of the active touch area 131 depends on the shapes of the beam paths, but also depends on the arrangement of emitters and detectors. In most applications, the active touch area is rectangular in shape, and the emitters and detectors are located along the four edges of the rectangle.

In a preferred approach, rather than having only emitters along certain edges and only detectors along the other edges, emitters and detectors are interleaved along the edges. FIG. 8E shows an example of this where emitters and detectors are alternated along all four edges. The shaded beams show the coverage area for emitter Ej.

F. Multiplexing

Since multiple emitters transmit multiple optical beams to multiple detectors, and since the behavior of individual beams is generally desired, a multiplexing/demultiplexing scheme is used. For example, each detector typically outputs a single electrical signal indicative of the intensity of the incident light, regardless of whether that light is from one optical beam produced by one emitter or from many optical beams produced by many emitters. However, the transmittance Tjk is a characteristic of an individual optical beam jk.

Different types of multiplexing can be used. Depending upon the multiplexing scheme used, the transmission characteristics of beams, including their content and when they are transmitted, may vary. Consequently, the choice of multiplexing scheme may affect both the physical construction of the optical touch-sensitive device as well as its operation.

One approach is based on code division multiplexing. In this approach, the optical beams produced by each emitter are encoded using different codes. A detector receives an optical signal which is the combination of optical beams from different emitters, but the received beam can be separated into its components based on the codes. This is described in further detail in U.S. Pat. No. 8,227,742, entitled “Optical Control System With Modulated Emitters,” which is incorporated by reference herein.

Another similar approach is frequency division multiplexing. In this approach, rather than modulated by different codes, the optical beams from different emitters are modulated by different frequencies. The frequencies are low enough that the different components in the detected optical beam can be recovered by electronic filtering or other electronic or software means.

Time division multiplexing can also be used. In this approach, different emitters transmit beams at different times. The optical beams and transmission coefficients Tjk are identified based on timing. If only time multiplexing is used, the controller cycles through the emitters quickly enough to meet a specified touch sampling rate.

Other multiplexing techniques commonly used with optical systems include wavelength division multiplexing, polarization multiplexing, spatial multiplexing and angle multiplexing. Electronic modulation schemes, such as PSK, QAM and OFDM, may also be possibly applied to distinguish different beams.

Several multiplexing techniques may be used together. For example, time division multiplexing and code division multiplexing could be combined. Rather than code division multiplexing 128 emitters or time division multiplexing 128 emitters, the emitters might be broken down into 8 groups of 16. The 8 groups are time division multiplexed so that only 16 emitters are operating at any one time, and those 16 emitters are code division multiplexed. This might be advantageous, for example, to minimize the number of emitters active at any given point in time to reduce the power requirements of the device.

III. Processing Phase

In the processing phase 220 of FIG. 2, the transmission coefficients Tjk are used to determine the locations of touch points. Different approaches and techniques can be used, including candidate touch points, line imaging, location interpolation, touch event templates, multi-pass processing and beam weighting.

A. Candidate Touch Points

One approach to determine the location of touch points is based on identifying beams that have been affected by a touch event (based on the transmission coefficients Tjk) and then identifying intersections of these interrupted beams as candidate touch points. The list of candidate touch points can be refined by considering other beams that are in proximity to the candidate touch points or by considering other candidate touch points. This approach is described in further detail in U.S. Pat. No. 8,350,831, “Method and Apparatus for Detecting a Multitouch Event in an Optical Touch-Sensitive Device,” which is incorporated herein by reference.

B. Line Imaging

This technique is based on the concept that the set of beams received by a detector form a line image of the touch points, where the viewpoint is the detector's location. The detector functions as a one-dimensional camera that is looking at the collection of emitters. Due to reciprocity, the same is also true for emitters. The set of beams transmitted by an emitter form a line image of the touch points, where the viewpoint is the emitter's location.

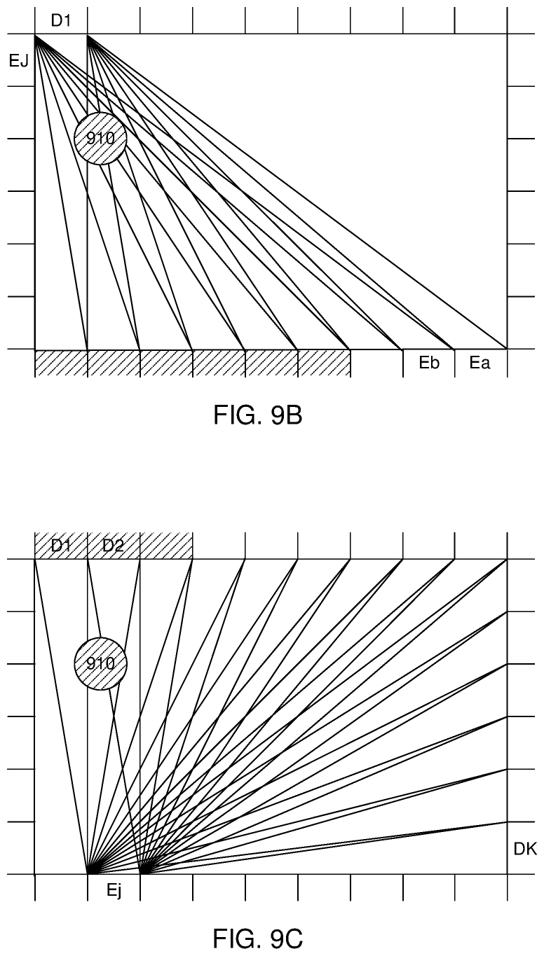

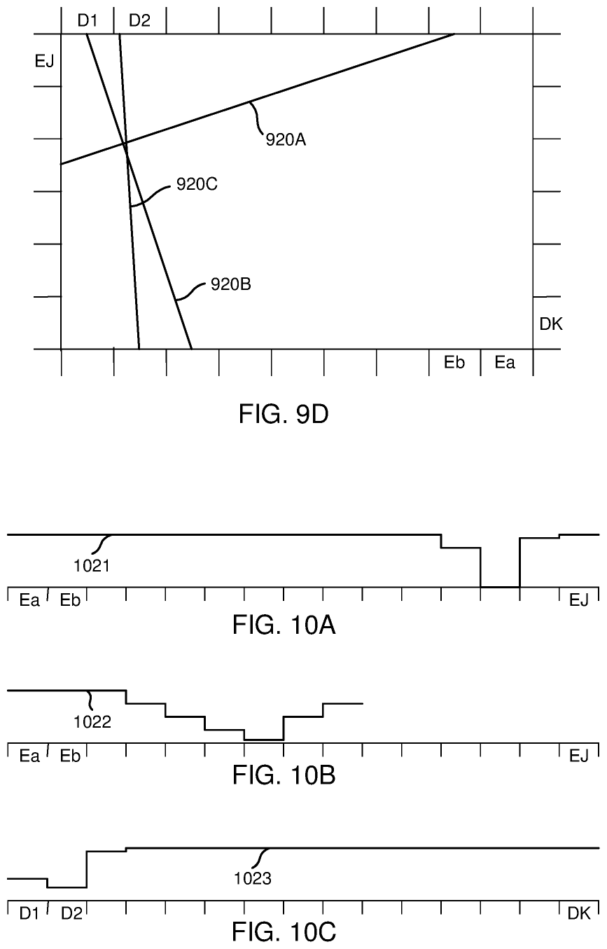

FIGS. 9-10 illustrate this concept using the emitter/detector layout shown in FIGS. 8B-8D. For convenience, the term “beam terminal” will be used to refer to emitters and detectors. Thus, the set of beams from a beam terminal (which could be either an emitter or a detector) form a line image of the touch points, where the viewpoint is the beam terminal's location.

FIGS. 9A-C shows the physical set-up of active area, emitters and detectors. In this example, there is a touch point with contact area 910. FIG. 9A shows the beam pattern for beam terminal Dk, which are all the beams from emitters Ej to detector Dk. A shaded emitter indicates that beam is interrupted, at least partially, by the touch point 910. FIG. 10A shows the corresponding line image 1021 “seen” by beam terminal Dk. The beams to terminals Ea, Eb, . . . E(J−4) are uninterrupted so the transmission coefficient is at full value. The touch point appears as an interruption to the beams with beam terminals E(J−3), E(J−2) and E(J−1), with the main blockage for terminal E(J−2). That is, the portion of the line image spanning beam terminals E(J−3) to E(J−1) is a one-dimensional image of the touch event.

FIG. 9B shows the beam pattern for beam terminal D1 and FIG. 10B shows the corresponding line image 1022 seen by beam terminal D1. Note that the line image does not span all emitters because the emitters on the left edge of the active area do not form beam paths with detector D1. FIGS. 9C and 10C show the beam patterns and corresponding line image 1023 seen by beam terminal Ej.

The example in FIGS. 9-10 use wide beam paths. However, the line image technique may also be used with narrow or fan-shaped beam paths.

FIGS. 10A-C show different images of touch point 910. The location of the touch event can be determined by processing the line images. For example, approaches based on correlation or computerized tomography algorithms can be used to determine the location of the touch event 910. However, simpler approaches are preferred because they require less compute resources.

The touch point 910 casts a “shadow” in each of the lines images 1021-1023. One approach is based on finding the edges of the shadow in the line image and using the pixel values within the shadow to estimate the center of the shadow. A line can then be drawn from a location representing the beam terminal to the center of the shadow. The touch point is assumed to lie along this line somewhere. That is, the line is a candidate line for positions of the touch point. FIG. 9D shows this. In FIG. 9D, line 920A is the candidate line corresponding to FIGS. 9A and 10A. That is, it is the line from the center of detector Dk to the center of the shadow in line image 1021. Similarly, line 920B is the candidate line corresponding to FIGS. 9B and 10B, and line 920C is the line corresponding to FIGS. 9C and 10C. The resulting candidate lines 920A-C have one end fixed at the location of the beam terminal, with the angle of the candidate line interpolated from the shadow in the line image. The center of the touch event can be estimated by combining the intersections of these candidate lines.

Each line image shown in FIG. 10 was produced using the beam pattern from a single beam terminal to all of the corresponding complimentary beam terminals (i.e., beam pattern from one detector to all corresponding emitters, or from one emitter to all corresponding detectors). As another variation, the line images could be produced by combining information from beam patterns of more than one beam terminal. FIG. 8E shows the beam pattern for emitter Ej. However, the corresponding line image will have gaps because the corresponding detectors do not provide continuous coverage. They are interleaved with emitters. However, the beam pattern for the adjacent detector Dj produces a line image that roughly fills in these gaps. Thus, the two partial line images from emitter Ej and detector Dj can be combined to produce a complete line image.

C. Location Interpolation

Applications typically will require a certain level of accuracy in locating touch points. One approach to increase accuracy is to increase the density of emitters, detectors and beam paths so that a small change in the location of the touch point will interrupt different beams.

Another approach is to interpolate between beams. In the line images of FIGS. 10A-C, the touch point interrupts several beams but the interruption has an analog response due to the beam width. Therefore, although the beam terminals may have a spacing of A, the location of the touch point can be determined with greater accuracy by interpolating based on the analog values. This is also shown in curve 720 of FIG. 7. The measured Tjk can be used to interpolate the x position.

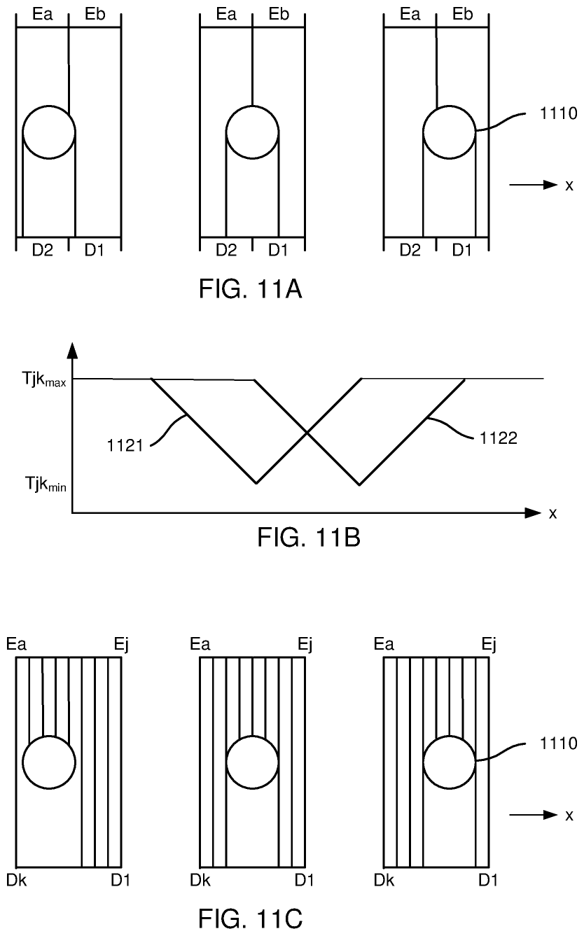

FIGS. 11A-B show one approach based on interpolation between adjacent beam paths. FIG. 11A shows two beam paths a2 and bl. Both of these beam paths are wide and they are adjacent to each other. In all three cases shown in FIG. 11A, the touch point 1110 interrupts both beams. However, in the lefthand scenario, the touch point is mostly interrupting beam a2. In the middle case, both beams are interrupted equally. In the righthand case, the touch point is mostly interrupting beam b 1.

FIG. 11B graphs these two transmission coefficients as a function of x. Curve 1121 is for coefficient Ta2 and curve 1122 is for coefficient Tb 1. By considering the two transmission coefficients Ta2 and Tb 1, the x location of the touch point can be interpolated. For example, the interpolation can be based on the difference or ratio of the two coefficients.

The interpolation accuracy can be enhanced by accounting for any uneven distribution of light across the beams a2 and bl. For example, if the beam cross section is Gaussian, this can be taken into account when making the interpolation. In another variation, if the wide emitters and detectors are themselves composed of several emitting or detecting units, these can be decomposed into the individual elements to determine more accurately the touch location. This may be done as a secondary pass, having first determined that there is touch activity in a given location with a first pass. A wide emitter can be approximated by driving several adjacent emitters simultaneously. A wide detector can be approximated by combining the outputs of several detectors to form a single signal.

FIG. 11C shows a situation where a large number of narrow beams is used rather than interpolating a fewer number of wide beams. In this example, each beam is a pencil beam represented by a line in FIG. 11C. As the touch point 1110 moves left to right, it interrupts different beams. Much of the resolution in determining the location of the touch point 1110 is achieved by the fine spacing of the beam terminals. The edge beams may be interpolated to provide an even finer location estimate.

D. Touch Event Templates

If the locations and shapes of the beam paths are known, which is typically the case for systems with fixed emitters, detectors, and optics, it is possible to predict in advance the transmission coefficients for a given touch event. Templates can be generated a priori for expected touch events. The determination of touch events then becomes a template matching problem.

If a brute force approach is used, then one template can be generated for each possible touch event. However, this can result in a large number of templates. For example, assume that one class of touch events is modeled as oval contact areas and assume that the beams are pencil beams that are either fully blocked or fully unblocked. This class of touch events can be parameterized as a function of five dimensions: length of major axis, length of minor axis, orientation of major axis, x location within the active area and y location within the active area. A brute force exhaustive set of templates covering this class of touch events must span these five dimensions. In addition, the template itself may have a large number of elements. Thus, it is desirable to simplify the set of templates.

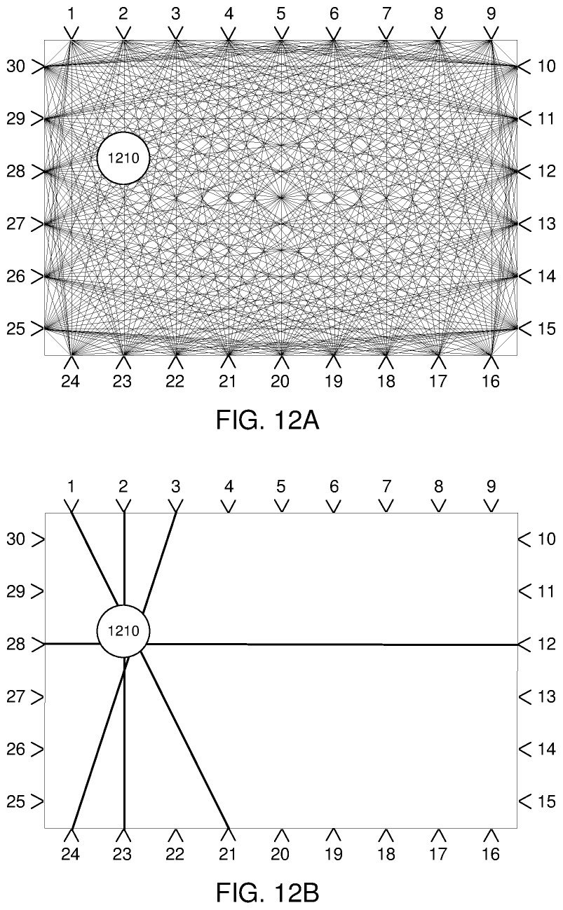

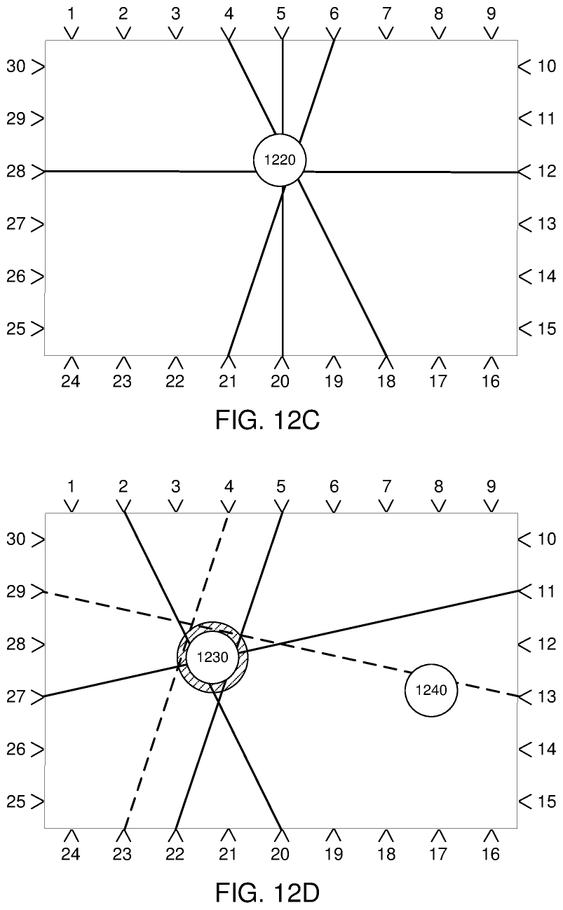

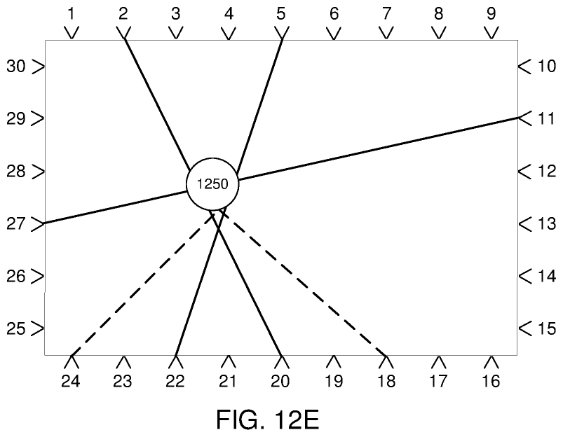

FIG. 12A shows all of the possible pencil beam paths between any two of 30 beam terminals. In this example, beam terminals are not labeled as emitter or detector. Assume that there are sufficient emitters and detectors to realize any of the possible beam paths. One possible template for contact area 1210 is the set of all beam paths that would be affected by the touch. However, this is a large number of beam paths, so template matching will be more difficult. In addition, this template is very specific to contact area 1210. If the contact area changes slightly in size, shape or position, the template for contact area 1210 will no longer match exactly. Also, if additional touches are present elsewhere in the active area, the template will not match the detected data well. Thus, although using all possible beam paths can produce a fairly discriminating template, it can also be computationally intensive to implement.

FIG. 12B shows a simpler template based on only four beams that would be interrupted by contact area 1210. This is a less specific template since other contact areas of slightly different shape, size or location will still match this template. This is good in the sense that fewer templates will be required to cover the space of possible contact areas. This template is less precise than the full template based on all interrupted beams. However, it is also faster to match due to the smaller size. These types of templates often are sparse relative to the full set of possible transmission coefficients.

Note that a series of templates could be defined for contact area 1210, increasing in the number of beams contained in the template: a 2-beam template, a 4-beam template, etc. In one embodiment, the beams that are interrupted by contact area 1210 are ordered sequentially from 1 to N. An n-beam template can then be constructed by selecting the first n beams in the order. Generally speaking, beams that are spatially or angularly diverse tend to yield better templates. That is, a template with three beam paths running at 60 degrees to each other and not intersecting at a common point tends to produce a more robust template than one based on three largely parallel beams which are in close proximity to each other. In addition, more beams tends to increase the effective signal-to-noise ratio of the template matching, particularly if the beams are from different emitters and detectors.

The template in FIG. 12B can also be used to generate a family of similar templates. In FIG. 12C, the contact area 1220 is the same as in FIG. 12B, but shifted to the right. The corresponding four-beam template can be generated by shifting beams (1,21) (2,23) and (3,24) in FIG. 12B to the right to beams (4,18) (5,20) and (6,21), as shown in FIG. 12C. These types of templates can be abstracted. The abstraction will be referred to as a template model. This particular model is defined by the beams (12,28) (i, 22−i) (i+1,24−i) (i+2,25−i) for i=1 to 6. In one approach, the model is used to generate the individual templates and the actual data is matched against each of the individual templates. In another approach, the data is matched against the template model. The matching process then includes determining whether there is a match against the template model and, if so, which value of i produces the match.

FIG. 12D shows a template that uses a “touch-free” zone around the contact area. The actual contact area is 1230. However, it is assumed that if contact is made in area 1230, then there will be no contact in the immediately surrounding shaded area. Thus, the template includes both (a) beams in the contact area 1230 that are interrupted, and (b) beams in the shaded area that are not interrupted. In FIG. 12D, the solid lines (2,20) (5,22) and (11,27) are interrupted beams in the template and the dashed lines (4,23) and (13,29) are uninterrupted beams in the template. Note that the uninterrupted beams in the template may be interrupted somewhere else by another touch point, so their use should take this into consideration. For example, dashed beam (13,29) could be interrupted by touch point 1240.

FIG. 12E shows an example template that is based both on reduced and enhanced transmission coefficients. The solid lines (2,20) (5,22) and (11,27) are interrupted beams in the template, meaning that their transmission coefficients should decrease. However, the dashed line (18,24) is a beam for which the transmission coefficient should increase due to reflection or scattering from the touch point 1250.

Other templates will be apparent and templates can be processed in a number of ways. In a straightforward approach, the disturbances for the beams in a template are simply summed or averaged. This can increase the overall SNR for such a measurement, because each beam adds additional signal while the noise from each beam is presumably independent. In another approach, the sum or other combination could be a weighted process, where not all beams in the template are given equal weight. For example, the beams which pass close to the center of the touch event being modeled could be weighted more heavily than those that are further away. Alternately, the angular diversity of beams in the template could also be expressed by weighting. Angular diverse beams are more heavily weighted than beams that are not as diverse.

In a case where there is a series of N beams, the analysis can begin with a relatively small number of beams. Additional beams can be added to the processing as needed until a certain confidence level (or SNR) is reached. The selection of which beams should be added next could proceed according to a predetermined schedule. Alternately, it could proceed depending on the processing results up to that time. For example, if beams with a certain orientation are giving low confidence results, more beams along that orientation may be added (at the expense of beams along other orientations) in order to increase the overall confidence.

The data records for templates can also include additional details about the template. This information may include, for example, location of the contact area, size and shape of the contact area and the type of touch event being modeled (e.g., fingertip, stylus, etc.).

In addition to intelligent design and selection of templates, symmetries can also be used to reduce the number of templates and/or computational load. Many applications use a rectangular active area with emitters and detectors placed symmetrically with respect to x and y axes. In that case, quadrant symmetry can be used to achieve a factor of four reduction. Templates created for one quadrant can be extended to the other three quadrants by taking advantage of the symmetry. Alternately, data for possible touch points in the other three quadrants can be transformed and then matched against templates from a single quadrant. If the active area is square, then there may be eight-fold symmetry.

Other types of redundancies, such as shift-invariance, can also reduce the number of templates and/or computational load. The template model of FIGS. 12B-C is one example.

In addition, the order of processing templates can also be used to reduce the computational load. There can be substantial similarities between the templates for touches which are nearby. They may have many beams in common, for example. This can be taken advantage of by advancing through the templates in an order that allows one to take advantage of the processing of the previous templates.

E. Multi-Pass Processing

Referring to FIG. 2, the processing phase need not be a single-pass process nor is it limited to a single technique. Multiple processing techniques may be combined or otherwise used together to determine the locations of touch events.

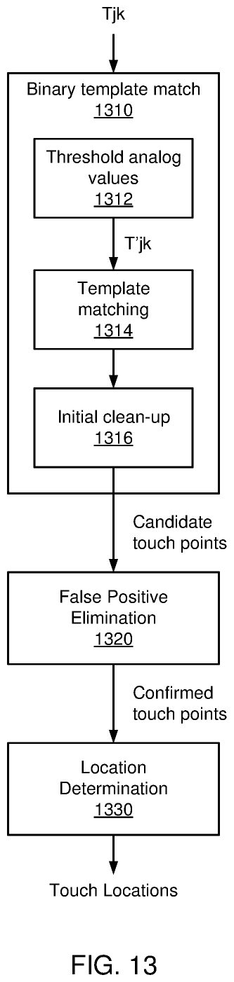

FIG. 13 is a flow diagram of a multi-pass processing phase based on several stages. This example uses the physical set-up shown in FIG. 9, where wide beams are transmitted from emitters to detectors. The transmission coefficients Tjk are analog values, ranging from 0 (fully blocked) to 1 (fully unblocked).

The first stage 1310 is a coarse pass that relies on a fast binary template matching, as described with respect to FIGS. 12B-D. In this stage, the templates are binary and the transmittances T′jk are also assumed to be binary. The binary transmittances T′jk can be generated from the analog values Tjk by rounding or thresholding 1312 the analog values. The binary values T′jk are matched 1314 against binary templates to produce a preliminary list of candidate touch points. Thresholding transmittance values may be problematic if some types of touches do not generate any beams over the threshold value. An alternative is to threshold the combination (by summation for example) of individual transmittance values.

Some simple clean-up 1316 is performed to refine this list. For example, it may be simple to eliminate redundant candidate touch points or to combine candidate touch points that are close or similar to each other. For example, the binary transmittances T′jk might match the template for a 5 mm diameter touch at location (x,y), a 7 mm diameter touch at (x,y) and a 9 mm diameter touch at (x,y). These may be consolidated into a single candidate touch point at location (x,y).

Stage 1320 is used to eliminate false positives, using a more refined approach. For each candidate touch point, neighboring beams may be used to validate or eliminate the candidate as an actual touch point. The techniques described in U.S. Pat. No. 8,350,831 may be used for this purpose. This stage may also use the analog values Tjk, in addition to accounting for the actual width of the optical beams. The output of stage 1320 is a list of confirmed touch points.

The final stage 1330 refines the location of each touch point. For example, the interpolation techniques described previously can be used to determine the locations with better accuracy. Since the approximate location is already known, stage 1330 may work with a much smaller number of beams (i.e., those in the local vicinity) but might apply more intensive computations to that data. The end result is a determination of the touch locations.

Other techniques may also be used for multi-pass processing. For example, line images or touch event models may also be used. Alternatively, the same technique may be used more than once or in an iterative fashion. For example, low resolution templates may be used first to determine a set of candidate touch locations, and then higher resolution templates or touch event models may be used to more precisely determine the precise location and shape of the touch.

F. Beam Weighting

In processing the transmission coefficients, it is common to weight or to prioritize the transmission coefficients. Weighting effectively means that some beams are more important than others. Weightings may be determined during processing as needed, or they may be predetermined and retrieved from lookup tables or lists.

One factor for weighting beams is angular diversity. Usually, angularly diverse beams are given a higher weight than beams with comparatively less angular diversity. Given one beam, a second beam with small angular diversity (i.e., roughly parallel to the first beam) may be weighted lower because it provides relatively little additional information about the location of the touch event beyond what the first beam provides. Conversely, a second beam which has a high angular diversity relative to the first beam may be given a higher weight in determining where along the first beam the touch point occurs.

Another factor for weighting beams is position difference between the emitters and/or detectors of the beams (i.e., spatial diversity). Usually, greater spatial diversity is given a higher weight since it represents “more” information compared to what is already available.

Another possible factor for weighting beams is the density of beams. If there are many beams traversing a region of the active area, then each beam is just one of many and any individual beam is less important and may be weighted less. Conversely, if there are few beams traversing a region of the active area, then each of those beams is more significant in the information that it carries and may be weighted more.

In another aspect, the nominal beam transmittance (i.e., the transmittance in the absence of a touch event) could be used to weight beams. Beams with higher nominal transmittance can be considered to be more “trustworthy” than those which have lower norminal transmittance since those are more vulnerable to noise. A signal-to-noise ratio, if available, can be used in a similar fashion to weight beams. Beams with higher signal-to-noise ratio may be considered to be more “trustworthy” and given higher weight.

The weightings, however determined, can be used in the calculation of a figure of merit (confidence) of a given template associated with a possible touch location. Beam transmittance/signal-to-noise ratio can also be used in the interpolation process, being gathered into a single measurement of confidence associated with the interpolated line derived from a given touch shadow in a line image. Those interpolated lines which are derived from a shadow composed of “trustworthy” beams can be given greater weight in the determination of the final touch point location than those which are derived from dubious beam data.

These weightings can be used in a number of different ways. In one approach, whether a candidate touch point is an actual touch event is determined based on combining the transmission coefficients for the beams (or a subset of the beams) that would be disturbed by the candidate touch point. The transmission coefficients can be combined in different ways: summing, averaging, taking median/percentile values or taking the root mean square, for example. The weightings can be included as part of this process: taking a weighted average rather than an unweighted average, for example. Combining multiple beams that overlap with a common contact area can result in a higher signal to noise ratio and/or a greater confidence decision. The combining can also be performed incrementally or iteratively, increasing the number of beams combined as necessary to achieve higher SNR, higher confidence decision and/or to otherwise reduce ambiguities in the determination of touch events.

### IV. Interaction Touch Objects

A. Introduction

Interaction touch objects (also referred to as interaction objects) are touch objects that can attach to a touch surface of a touch device (e.g., optical touch-sensitive device 100). When one or more interaction objects are attached to the touch surface, a user may interact with an interaction object (e.g., via a control on the object) and may interact with the touch surface using other touch objects, such as a stylus or finger. Interaction with the touch device may be enhanced by the use of these interaction objects. For example, an interaction object can enable a user to select a chosen operating mode without having to navigate menus.

Interaction objects include one or more mounting couplers that attach them to the touch surface. A mounting coupler results in an interaction object be retained on a touch surface without a user holding it to the surface. Interaction objects may be retained on a substantially horizontal touch interaction surface by gravity, but other means can be used when gravity is unsuitable, such as when the interaction surface is substantially inclined or vertical, or if the touch surface is subject to movement or vibration (such as on a mobile phone). Methods of adhesion for interaction objects include magnets, suckers, hook and loop fasteners, and releasable adhesives. Dedicated retaining structures may also be present on the interaction surface, such as ledges and cut-outs into which interaction objects can be placed. In some embodiments, interaction objects are removably attached to the surface. For example, a user can detach and reattach an interaction object any number of times (e.g., to move the object). For example, an interaction object magnetically attaches to the surface so that a user can easily detach the object from the surface. In other embodiments, interaction objects are permanently attached to the surface.

Typically, the touch surface is on or in front of a display under control of a display device. In this configuration, an interaction object on the surface can activate or adjust modes, settings, and features of the device, and generally enable communication and responsive interaction with the devices. In some embodiments, the display is not behind the touch surface. For example, the touch surface is part of a touchpad that is physically separate from a display.

Although the display may be of any type, including LED, OLED, LCD, or CRT (Cathode Ray Tube), it may be advantageous to utilize a thin display, such as a thin LCD or an OLED, so that magnetic retention of objects can be more easily used. Magnets in the interaction objects may not need to be unduly powerful since the distance over which magnetic attraction is available may be short (e.g., a few millimeters). OLED display panels may be particularly suitable since they commonly make use of ferromagnetic materials in their construction, to which magnetic interaction objects may readily attach without modification. Other thin display panels can be configured with ferromagnetic sheets (e.g., behind or in them) to facilitate magnetic retention of interaction objects. Naturally, magnets can alternatively or additionally be present behind the display, but it may be more convenient for the magnetic component to reside mainly or completely in the interaction objects.

Smooth surfaces, such as those of high-gloss glass and polymer surfaces are particularly suited for retention using one or more suckers which can be pushed onto the surface, expelling air and giving rise to a pressure differential used to hold an interaction object in position. The suckers may also give rise to touch events on the surface, and those can be identified as being associated with a particular interaction object based on the configuration (e.g., a combination of sizes, types, locations, orientations, etc. of the suckers).

Interaction objects include one or more contact portions on a contact side of the object (contact portions may also be referred to as contacts or touch protrusions). When an interaction object is attached to a touch surface, the contact portions contact the touch surface and cause one or more touch events. Thus, the interaction object type, position, orientation, and parametric settings can be determined by the touch-sensitive device by analyzing characteristics of the touch events caused by the contact portions. In the example of an optical touch-sensitive device 100, the device 100 may recognize an interaction object using methods similar to the optical methods used to detect touch objects (described above). For example, light passing in front of the touch surface or light propagating within a waveguide acting as a touch surface can be used.

Interaction objects are generally described herein relative to an optical touch-sensitive device (e.g., device 100). In some embodiments, interaction objects are specifically designed to be used with optical touch-sensitive devices. However, interaction objects are not limited to optical touch-sensitive devices. Interaction objects may be used with any type of touch-sensitive device (e.g., capacitive or resistive type touch-sensitive devices). For example, an interaction object has a specific resistance such that a resistive touch-sensitive device may recognize the interaction object on a surface. In some embodiments, an interaction object is designed to be used with any type of touch-sensitive device.

That being said, the optical sensing methods used by an optical touch-sensitive device may be advantageous relative to other sensing methods, such as projected capacitance, because optical sensing methods generally do not require a touch object to have a large repository for electric charge (such as a human body), so an interaction object may be detected and sensed when not in contact with a person. Also, optical sensing methods may detect small-scale (e.g., a few light wavelengths in dimension) interactions with the touch device so that optically sensed attributes of the interaction objects may be analyzed in detail. Example, methods of identifying and analyzing touch objects are described in U.S. patent application Ser. Nos. 16/389,574 and 16/279,880 and U.S. Pat. Nos. 9,791,976 and 10,402,017. The subject matter of these patents and patent applications are incorporated herein by reference in their entirety.

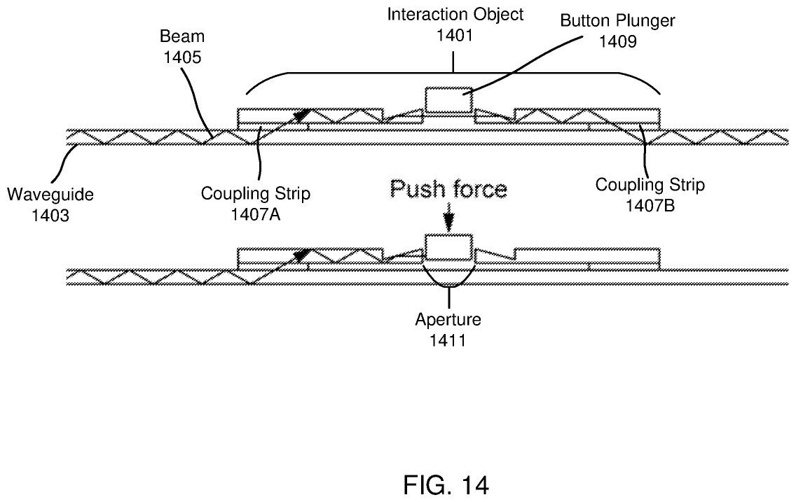

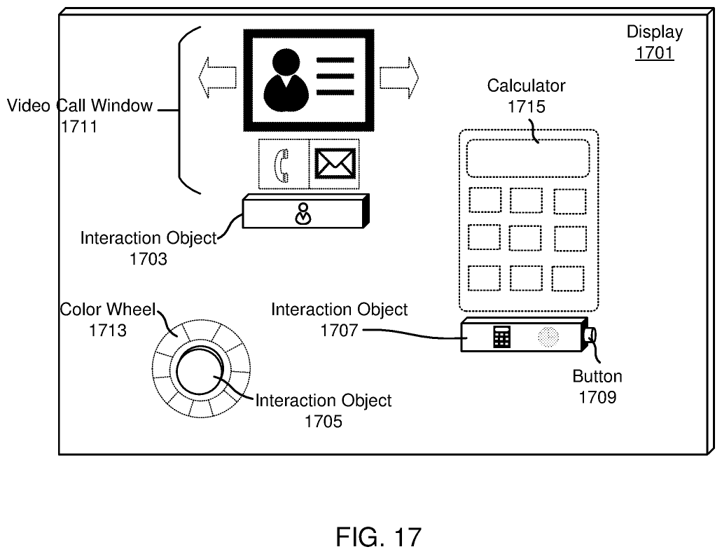

In some embodiments, a user can interact with one or more controls (also referred to as user-interactable controls) of an interaction object. Example controls include buttons, sliders, and rotary controls. When a control is engaged by a user (e.g., the button is pressed), the interaction object may interact with the touch surface differently so that the touch system can determine when the control is engaged. For example, an interaction with a control changes a characteristic of a touch event caused by the touch object. Thus, the user can interact with the touch device via one of more controls on an interaction object. Controls are further described below, for example with reference to FIGS. 14 and 17.

An interaction object may be an active or a passive touch object. Passive touch objects interact with the optical beams transmitted between emitters and detectors (or another touch sensing mechanism) but do not but do not include electronic components or a power source. Active touch objects include a power source and electronic components that interact with the touch-sensitive device. Active touch objects may add energy and may contain their own emitter(s) and detector(s). Active touch objects may contain a communications channel, for example a wireless connection, in order to coordinate their operation with the rest of the touch-sensitive device.

Interaction objects may be small enough that a user can carry one in their pocket. Interaction objects may reside in a convenient location such as on a table or an accessory tray similar to those associated with traditional liquid-ink whiteboards and typically just below the writing area).

B. Waveguide-Based Optical Sensing

For TIR touch devices, an optical waveguide is used as the interaction surface and may be disposed in front of an electronic display panel (e.g., substantially parallel to the display surface of the panel). When used with a display, the waveguide is usually transparent (or at least partially transparent) to visible wavelengths so that the displayed images can be seen by a user. There may be two types of object interactions with the beams propagating through the waveguide: light diversion and direct modulation.

Light diversion is where the contacting interaction object forms an optical bond (e.g., it becomes optically coupled) with the waveguide surface, directing some or all of the beams into the interaction object. This can be done using compliant optical coupling elements or an optically clear adhesive. The diverted light may subsequently be reintroduced into the waveguide surface through another coupling element or adhesive bond. Light diversion may redirect one or more beams in a distinctive manner which can be identified, or enable the beams to be modulated (for example, the intensity of the light, its direction, or wavelength-related intensity) in such a way that parametric settings of physical controls on the interaction object can be determined by the touch device 100.

Direct modulation of light paths within the waveguide may be applied by having surfaces of the interaction object contact the waveguide surface and modify the sensing light propagating in it. For example, compliant bumps on a surface of the interaction object surface disturb light propagating by total internal reflection in the waveguide. Also, (e.g., simple) structures of an interaction object may optically couple to the waveguide surface and modify the light incident upon them. For example, a reflective structure can change the angle of the light within the waveguide. In another example, a small-scale geometric structure can result in a level of attenuation which is related to the azimuthal angle of the light path within the waveguide. Example modulation methods and structures are described in U.S. patent application Ser. No. 16/156,817. This subject matter is incorporated herein by reference in its entirety.

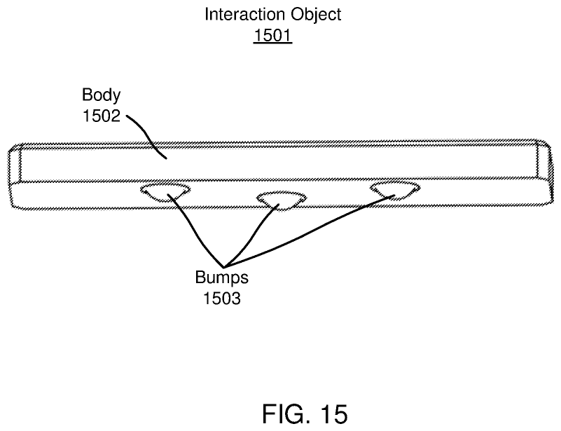

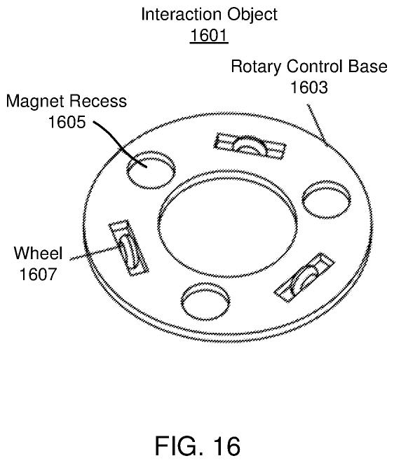

FIG. 14 includes cross sectional images of an interaction object 1401 attached to a waveguide 1403 of an optical touch-sensitive device, according to an embodiment. The top image shows a button plunger 1409 in an unpressed state and the bottom image shows the button plunger 1409 in a pressed state. Coupling strips 1407A and 1407B attach (e.g., removably attach) the object 1401 to the surface of the waveguide 1403. Additionally, a beam 1405 is diverted from the waveguide 1403 into the interaction object 1401 through an optical coupling strip 1407A (e.g., coupling strip 1407A includes optically transparent adhesive). The object 1401 includes a button plunger 1409 in an aperture 1411. The object 1401 will generally have a detectable impact on optical beam 140 regardless of whether the button plunger 1409 is depressed. Thus, the presence of the object 1401 on the waveguide may be detected. However, the optical path of the beam 1405 through the aperture 1411 is blocked when the button plunger 1409 is pushed but the beam 1405 passes across the aperture 1411 and is coupled back into the waveguide 1403 via the second coupling strip 1407B when the button plunger 1409 is not depressed. Thus, the touch-sensitive device may determine the state of the plunger button 1409 (pressed on not pressed) based on its interactions with optical beams in the waveguide. In other words, the button plunger 1409 is an example of a user-interactable control. In this embodiment, the coupling strips 1407 act as mounting couplers and contact portions. In other embodiments (e.g., as seen in FIGS. 15 and 16), a mounting coupler and contact portion are different components.

FIG. 15 is a perspective view of a rectangular interaction object 1501, according to an embodiment. The object 1501 includes three rubber bumps 1503 on the underside of a body 1502 which will contact a touch surface when the object is attached to a touch surface. The size of the bumps 1503 and locations of the bumps 1503 relative to each other form a pattern of touches that is recognizable by a touch-sensitive device. The orientation of the interaction object 1501 may be determined from the orientation of the pattern formed by the bumps 1503. Consequently, a change in orientation of the interaction object 1501 may be interpreted as a command to change a behavior of the touch-sensitive device. Similarly, the size (e.g., radius) of the bumps 1503 may be used to determine the force with which a user is pushing the interaction object towards the waveguide. Furthermore, the relative sizes of the different bumps 1503 may be used to determine where on the object 1501 the user is pushing. For example, pushing down on the left side will cause the contact area between the bump nearer the left end and the waveguide to increase more than the contact area between the bump nearer the right end and the waveguide. Thus, one use of an interaction object 1501 such as the one shown in FIG. 15 might be to issue “left” and “right” commands (e.g., to change what is displayed on a screen of the touch-sensitive device to a previous or next page). Magnets (e.g., embedded in the body 1502) may retain the object 1501 to the touch surface. The bumps 1503 are examples of contact portions, and the unillustrated magnets are examples of mounting couplers.

As described above, interaction objects may be designed for a user to interact with them via a control. For example, an interaction object includes a button or is configured to rotate. In these embodiments, mechanical interaction with an interaction object may take place by modifying how the interaction object interacts with the beams. A push button can be implemented as a plunger with a compliant material at the end, which is pushed against the optical waveguide surface when the button is pushed by a user. When the compliant material contacts the sensing waveguide, it disturbs the optical beams propagating through the waveguide. Rotary controls may be implemented using one or more contact portions that move by rotating the object.

Sliding and rotational interactions can be implemented using materials which move over the sensing surface (e.g., with little friction). It may be advantageous to use wheels or balls to perform this function. An example rotary control for use directly on a waveguide surface uses compliant wheels (e.g., with tires) to allow freedom of movement while maintaining continuous contact with the surface. Contacts that roll, such as wheels, may be advantageous over contacts which slide along the waveguide surface because sliding contacts may trap air between the waveguide and the contact. Trapped air may reduce the optical coupling between the moving contact and the waveguide. A wheel or other similar device maintains contact with the waveguide surface in a way which maintains or increases the optical interaction because there is little or no movement of the surfaces relative to one another.

FIG. 16 is a perspective view of an interaction object 1601, according to an embodiment. The interaction object 1601 includes a cylindrical rotary control base 1603 that a user may rotate relative to the touch surface while the object 1601 is attached to the touch surface. The base 1603 includes magnet recesses 1605 that hold magnets (not illustrated) which keep the object 1601 physically coupled to the touch surface. The base 1603 also includes wheels 1607 which allow a user to rotate the base 1603. The rotational axes of the wheels 1607 are parallel to a radial direction of the object 1601. The wheels 1607 are examples of contact portions, and the unillustrated magnets are examples of mounting couplers.

C. Air-Based Optical Sensing

Interaction objects used for OTS touch devices may be similar to the objects described above. There may be some differences though. For example, touch object configurations for OTS devices may have such as more freedom with regard to contact between the object and the touch surface as well as compliance in object contact surfaces.

Specifically, since there may be no waveguide, there may not be a need for light diversion. Thus, interaction objects and/or their controls may directly modulate the optical paths. For example, a button can take the form of a mechanical plunger displaced by applied force (for example, with a spring-return mechanism) which intrudes into an optical sensing path and blocks the optical transmission, or modifies it in another way, such as inserting a reflector, refractor, a piece of optical filter material or optical polarizer.

D. Identifying Interaction Objects

As mentioned above, characteristics of the touches generated by an interaction object (e.g., the combination of sizes, types, locations, and orientations) can be used for identification of interaction objects as distinct from other touch objects (e.g., styli).

An additional characteristic which may be used for interaction object identification is the stability (e.g., lack of movement and variation) of one or more touch events generated by a contact portion (e.g., a sucker) of an interaction object. Since interaction objects are physically coupled to the touch surface, touch events caused by them are typically more stable than touch events from a human finger or handheld instrument (e.g., a stylus). The reduction (e.g., absence) of movement and variation in a touch or touches (e.g., within a threshold time period) can be an indication of whether the configuration of touches is associated with an interaction object or with an arrangement of other touch object types.

Another touch event characteristic that may be used to identify an interaction object is the touch strength of one or more touch events. Similar to the stability characteristic described above, a touch strength of touches generated by an interaction object may be more stable and/or consistent than touches from touch objects held by a user since a user may intentionally or unintentionally vary a touch strength of an object they are holding to the surface.

Additionally or alternatively, the time of occurrence of touch events (e.g., the start times of touch events) relative to each other may be used as a characteristic. Specifically, the time relationship between a set of touch events may be used as a criterion to differentiate interaction objects from one another and from other touch objects, such as fingers. For example, non-interaction objects may cause multiple touch events that occur at different times or only cause a single touch event. On the other hand, interaction objects with multiple contact portions may cause touch events that occur within a threshold time interval of each other (assuming the contact portions are approximately co-planar and the touch surface is approximately flat). This may especially be true for interaction objects with four or more contact portions.

The contact portions of interaction objects may have various shapes which make then identifiable and distinguishable over other touch objects. For example, interaction objects include bumps resulting in pointed or rounded contacts of various sizes and configurations. In another example, an interaction object causes a non-circular and non-oval touch event since fingers and styli typically cause circular or oval touch events. Contact portion shapes such as rectangles (e.g., elongated strips or bars) may be particularly effective because they are dissimilar to common touch object shapes such as those generated by fingers or styli. Elongated strips or bars may also provide distinct features such as the aspect ratio of the touch and the orientation of the touch shape. A small number (such as three or four) of these touch protrusions on the underside of an interaction object can encode a lot of different object types and/or modal information about the object.

Another touch event characteristic that may be used to identify an interaction object is the locations of touch events relative to each other. Some interaction objects include an arrangement of contact portions. Thus, the touch object may cause a set of touch events that have a constant spatial relationship to each other. This constant spatial relationship may be recognizable by a touch-sensitive device.

E. Interactions

When an interaction object is detected on the surface, a display coupled to the touch device may display graphical indications that the interaction object has been recognized. For example, graphical renderings of appropriate indicia on the display in proximity to the interaction object may be particularly effective. An example of object-based interaction is a long rectangular block object with magnets embedded in it (e.g., attracted to a ferromagnetic sheet behind the display) and rubber bumps on the underside in a defined pattern. An example contact portion pattern is a triangular configuration of bumps so that all three can touch the sensing surface even if it is not perfectly flat. The specific configuration (spacing and pattern) of the bumps along with the stability of them, and the likelihood that they arrive within a few hundred milliseconds of one another may provide a robustly detectable set of touch events, readily differentiable from finger-based touch activity or the arrival of other interaction objects.

On detection of such an object, the graphical content of the display (typically, but not necessarily, in the area close to the interaction object) can respond to it. For example, an interaction object may have the function of initiating a video conference call mode. When this video call object is detected on the surface, the touch object determines the orientation of the object based on a pattern of bumps. The display then displays a video call window that is aligned with the video call object on the surface (e.g., above a first long edge of the object), even if it is at an arbitrary angle relative to the axis of the display. The video call window may present contact information (e.g., a picture and name) associated with a user or session. The display may also display buttons (e.g., below a second long edge of the video call object) to navigate or change the contact information. The on-screen buttons may be used to step forward or backwards through the available contacts and to select one to call (or an existing scheduled call to join). When making a call, the video call window may then be used to show the video feed from the other end, or a composition of other video feeds from one or more parties on the call.

In some embodiments, some or all buttons for controlling the call behavior are physical buttons in the video call object, actuated by physical manipulation by the user. For example, a spring-loaded plunger can form a button mechanism which pushes a suitable (e.g., compliant) material onto the waveguide surface when a force is applied to the button. If the touch system is an OTS system, the button action may push the plunger into the path of incident light which is then modulated or modified (e.g., attenuated, filtered, redirected, or polarized).

An interaction object may include an optional physical button (or another type of control) to disable or stop the responsive graphics associated with the interaction object and return the display to a state which would apply if the interaction object had been removed. Pressing the button again may re-enable the interaction mode of the display and interaction object. For example, the video call object includes a button. When the object is on the surface and the button is pressed, the display displays the video call window. If the button is pressed again, the display stops displaying the video call window (even if the object is still on the surface).

Other examples of interaction objects include:

(1) An interaction object which results in a display displaying a calendar or schedule. An interface may allow calendar events to be seen and edited by a user.

(2) An interaction object which results in a display displaying a calculator. For example, a calculator display is displayed above the object and a calculator keyboard is displayed below the object.

(3) An interaction object which results in the display displaying a settings menu. The menu may allow a user to adjust system settings, such as display brightness, text language, and network settings.

(4) An interaction object which results in the display “freezing” drawn content on the display (e.g., drawn by a finger or stylus) such that other content can be drawn over the “frozen” content while the object is present but removed when the object is removed (e.g., while preserving the drawn content which was drawn before the object was applied to the surface).

(5) An interaction object which results in the display displaying a keypad or keyboard for data or text entry (or other interactive functions).

(6) An interaction object which includes a physical keypad or keyboard (implemented as a set of physically operated controls, such as buttons, which have an optical effect as previously described) for data or text entry (or other interactive functions).

(7) An interaction object which results in an operating system opening an application. The display may display a user interface of the application relative to the location and orientation of the object. For example, the interface is centered above the location of the object on the surface.

(8) An interaction object which includes a physically rotatable element where rotation of that element is optically detected by disturbance of the optical paths in the area. One example embodiment of this is a rotary control with three wheels on the underside arranged to allow rotation. The control can be retained on the surface by any of the previously described methods, but magnetic retention being particularly effective.

(9) An interaction object which results in the display not displaying any images associated with the object. For example, despite the touch device detecting and identifying the object, the presence of the object on the surface is intentionally ignored. This object may provide support for another touch interaction. For example, the object is used as a straight edge rule that enables a stylus or finger to draw a straight line. Without the object identification capability, such an object may generate spurious touch events which may disturb the system. Detection without response allows this category of interaction objects to be used with fewer or no unintended effects. As well as straight edge rulers, stencils, curved guides, protractors, cup-holders, instrument holders, and measurement jigs of all kinds may be presented to the touch surface without resulting in associated images being displayed. In some embodiments, the display displays an indicator that informs the user of the function of the object. For example, the display displays text such as “ruler” above the object if the object is assigned to perform the ruler function.

An interaction object may have a shape which indicates the function it is intended to perform, or it may have graphical (or text) content on it to provide that indication. Additionally or alternatively, graphical content derived from on-screen icon representations may be used. This represents a natural user interface, where familiar iconic representations of actions or features are used to inform the user. An example is shaping the interaction object like a paint palette to indicate that it can be used to select a color for drawing or writing. Another example is a system settings interaction object (see item (3) above) that includes a picture of a gearwheel, which is commonly used in operating systems to indicate a settings menu.

FIG. 17. shows three different interaction objects 1703, 1705, and 1707 on a display 1701, according to an embodiment. In the example, of FIG. 17, the display 1701 is behind a touch surface (not illustrated). Said differently, the touch surface is between the interaction objects and the display 1703. The presence of the interaction objects on the touch surface results in the display 1701 displaying associated user interfaces (these interfaces are illustrated with dotted lines). Object 1701 is a video call object that results in the display 1701 displaying an example video call window 1711. Object 1705 is rotatable and results in a color wheel interface 1713 being displayed. By rotating object 1705, a user may be able to change an ink color of stylus. Object 1707 results in the display of calculator interface 1715. Object 1707 includes a button 1709. By pressing the button 1709, the calculator interface 1715 may change. For example, the calculator is replaced with a clock or calendar.

F. Modal Behavior

In some embodiments, it is useful for one or more interaction objects to have defined and invariant functions regardless of the context in which they are used. For example, an interaction object is used to launch a particular application in any context when it is placed on the surface.

However, other interaction objects may have modal behavior that is related to the context. An example is an interaction object with a rotary control that may be used in a collaborative digital whiteboard device or application. When placed on the surface, rotating the control may scroll the writing surface from left to right or right to left as if it were a continuous piece of “paper” on a roll. The same object placed on a video call window (for example triggered by placement of a video call object on the surface) may allow the sound level to be adjusted by rotating the control. When placed on or near the on-screen buttons which step through the contacts to be called, the rotating the control may allow rapid navigation of the contacts. Similarly, the same object placed on a diary, calendar, or schedule window may allow rapid navigation of the hours, days, or months by turning the control quickly and then more slowly and precisely. The same object may be placed on a settings menu to allow settings such as display brightness to be adjusted by rotating the control, which may be preferable to adjustment using button-driven discrete steps.

G. Accessibility

Apart from their utility in providing (e.g., direct and immediate) access to features, menus, and applications, interaction objects may also address user interface accessibility issues for users with specific requirements (e.g., physical handicaps). For example, initiating or joining a video call using conventional conferencing systems may require touch activation of a button or menu which is too high to reach for a user in a wheelchair. By having an interaction object on-hand, a user with specific requirements can place the interaction object on the display to trigger a desired function and also to anchor the associated interactive graphical responses at a location suitable for the user with little or no further instructions from the user. For example, a user in a wheelchair can place a video call interaction object at a location on the display that is suitable for the user. In response, the video call window may be displayed near the object (e.g., above or below the object). This allows the user in the wheelchair to interact with the video call window (e.g., start a video call) at a location on the display that is suitable for the user.

It may also advantageous that the on-screen user interface may not need to be adjusted for systems which support interaction objects compared to ones which do not. This means that a consistent user interface can be presented for devices with and without object interaction features, where the presentation of an interaction object may only result in the intended interactive response on a system which supports it. For example, a color picker of a drawing application may be accessed via an interaction object for systems that support interaction objects and may be accessed via a menu for systems that do not support interaction objects.

H. Method of Interacting with Interaction Touch Object

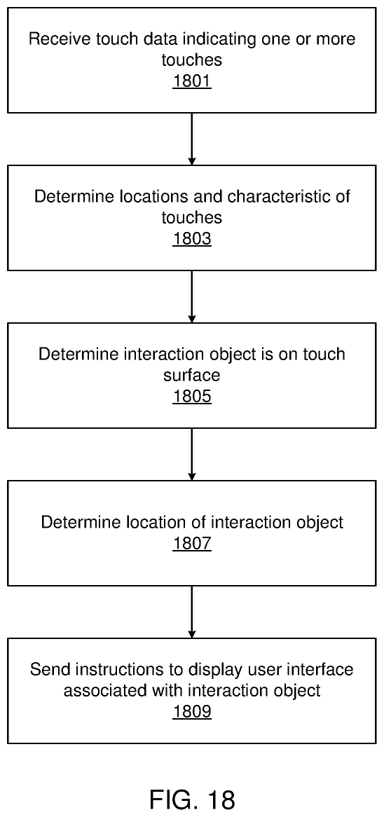

FIG. 18 is a flow chart illustrating a method of interacting with an interaction touch object by a touch-sensitive device, according to an embodiment. The touch-sensitive device detects touch events on a touch surface. The touch surface is in front of a display that is coupled to the touch-sensitive device. The method steps may be performed from the perspective of a controller of the touch-sensitive device (e.g., controller 110). The steps of method may be performed in different orders, and the method may include different, additional, or fewer steps.

The controller receives 1801 touch data from one or more detectors of the touch-sensitive device. The touch data indicates one or more touch events on the touch surface. The controller determines 1803 locations and another characteristic of the one or more touch events on the touch surface based on the touch data. The controller determines 1805 an interaction touch object is on the touch surface based on the other characteristic. The interaction touch object is attached to the touch surface and includes a contact portion in contact with the touch surface and causing the one or more touch events. The controller determines 1807 a location of the interaction touch object based on the locations of the one or more touch events. Responsive to determining the interaction touch object is on the touch screen and determining the location of the interaction touch object, the controller sends 1809 instructions to the display to display a user interface associated with the interaction touch object. A location of the user interface on the display is based on the location of the interaction touch object on the touch surface.

In some embodiments, at least a portion of the user interface on the display is displayed above the location of the interaction touch object on the touch surface. In some embodiments, the controller determines an orientation of the interaction touch object relative to the touch surface. An orientation of the user interface is based on the orientation of the interaction touch object. In some embodiments, the other characteristic is at least one of: a shape of the one or more touch events, a size of the one or more touch events, a total number of the one or more touch events, an orientation of the one or more touch events, a total number of the one or more touch events, changes to the locations of the one or more touch events within a threshold time period, locations of the one or more touch events relative to each other, or time of occurrences of the one or more touch events relative to each other.

### V. Applications

The touch-sensitive devices and methods described above can be used in various applications. Touch-sensitive displays are one class of application. This includes displays for tablets, laptops, desktops, gaming consoles, smart phones and other types of compute devices. It also includes displays for TVs, digital signage, public information, whiteboards, e-readers and other types of good resolution displays. However, they can also be used on smaller or lower resolution displays: simpler cell phones, user controls (photocopier controls, printer controls, control of appliances, etc.). These touch-sensitive devices can also be used in applications other than displays. The “surface” over which the touches are detected could be a passive element, such as a printed image or simply some hard surface. This application could be used as a user interface, similar to a trackball or mouse.

### VI. Additional Considerations

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation, and details of the method and apparatus disclosed herein.

What is claimed is:

1. A system comprising:
a touch surface;
emitters and detectors, the emitters producing optical beams that propagate across the touch surface and are received by the detectors, wherein touch events on the touch surface disturb the optical beams;
an interaction touch object configured to attach to the touch surface and to cause one or more touch events when the interaction touch object is attached to the touch surface by disturbing one or more beams emitted by the emitters; and
a controller configured to:
receive beam data from the detectors for optical beams disturbed by the interaction touch object;
determine locations and an additional characteristic of the one or more touch events caused by the interaction touch object based on the beam data; and
determine the interaction touch object is on the touch surface based on the additional characteristic and determine a location of the interaction touch object based on the locations of the one or more touch events.

2. The system of claim 1, further comprising a display behind the touch surface, wherein the display displays images associated with the interaction touch object responsive to the controller determining the interaction touch object is on the touch surface and determining a location of the interaction touch object.

3. The system of claim 1, wherein the additional characteristic is at least one of: shapes of the one or more touch events, sizes of the one or more touch events, a total number of the one or more touch events, orientations of the one or more touch events, changes to the locations of the one or more touch events within a threshold time period, locations of the one or more touch events relative to each other, or time of occurrences of the one or more touch events relative to each other.

4. The system of claim 1, wherein the interaction touch object is removably attached to the touch surface.

5. The system of claim 1, wherein the interaction touch object includes a user-interactable control, wherein an interaction with the control changes how the interaction touch object disturbs the one or more beams.

6. An interaction touch object configured to interact with a touch-sensitive device, the touch-sensitive device configured to detect touch events on a touch surface, the object comprising:
a mounting coupler configured to, responsive to a user placing the interaction touch object on the touch surface, attach the interaction touch object to the touch surface of the touch-sensitive device; and
a contact portion configured to contact the touch surface of the touch-sensitive device and cause a touch event when the interaction touch object is attached to the touch surface by the mounting coupler, wherein the touch-sensitive device is configured to determine the interaction touch object is on the touch surface based on a characteristic of the touch event caused by the contact portion.

7. The interaction touch object of claim 6, wherein the touch-sensitive device is an optical touch-sensitive device and the contact portion is configured to disturb one or more beams that propagate across the touch surface, the one or more beams emitted by one or more emitters and detected by one or more detectors.

8. The interaction touch object of claim 6, wherein the mounting coupler and the contact portions are a same component of the interaction touch object.

9. The interaction touch object of claim 6, wherein the mounting coupler and the contact portion are different components of the interaction touch object.

10. The interaction touch object of claim 6, wherein the mounting coupler removably attaches the interaction touch object to the touch surface.

11. The interaction touch object of claim 6, wherein the mounting coupler includes a magnet to magnetically attach the interaction touch object to the touch surface.

12. The interaction touch object of claim 6, wherein the mounting coupler includes at least one of: a sucker, a hook and loop fastener, or releasable adhesive to attach the interaction touch object to the touch surface.

13. The interaction touch object of claim 6, wherein the contact portion includes one or more wheels.

14. The interaction touch object of claim 6, wherein the interaction touch object further includes a user-operable control, wherein an interaction with the control changes the characteristic or a second characteristic of the touch event caused by the contact portion.

15. The interaction touch object of claim 6, wherein a shape of the touch event caused by the contact portion is non-circular in shape.

16. A method of interacting with an interaction touch object by a touch-sensitive device, the touch-sensitive device configured to detect touch events on a touch surface, the touch surface being in front of a display that is coupled to the touch-sensitive device, the method comprising:
receiving touch data from one or more detectors of the touch-sensitive device, the touch data indicating one or more touch events on the touch surface;
determining locations and an additional characteristic of the one or more touch events on the touch surface based on the touch data;
determining an interaction touch object is on the touch surface based on the additional characteristic, wherein the interaction touch object is attached to the touch surface and includes a contact portion in contact with the touch surface and causing the one or more touch events;
determining a location of the interaction touch object based on the locations of the one or more touch events; and
responsive to determining the interaction touch object is on the touch screen and determining the location of the interaction touch object, sending instructions to the display to display a user interface associated with the interaction touch object, wherein a location of the user interface on the display is based on the location of the interaction touch object on the touch surface.

17. The method of claim 16, wherein at least a portion of the user interface on the display is displayed above the location of the interaction touch object on the touch surface.

18. The method of claim 16, further comprising determining an orientation of the interaction touch object relative to the touch surface, wherein an orientation of the user interface is based on the orientation of the interaction touch object.

19. The method of claim 16, wherein the user interface is a video call window that allows a user to make a call.

20. The method of claim 16, wherein the additional characteristic is at least one of: shapes of the one or more touch events, sizes of the one or more touch events, a total number of the one or more touch events, orientations of the one or more touch events, changes to the locations of the one or more touch events within a threshold time period, locations of the one or more touch events relative to each other, or time of occurrences of the one or more touch events relative to each other.
